(19) United States
(12) Patent Application Publication
(10) Pub. No.: US 2020/0005183 A1
(43) Pub. Date: Jan. 2, 2020

(54) EVALUATION METHOD FOR LEARNING MODELS, TRAINING METHOD, DEVICE, AND PROGRAM

(71) Applicant: RENESAS ELECTRONICS CORPORATION, Tokyo (JP)

(72) Inventors: Tadaaki TANIMOTO, Tokyo (JP); Motoki KIMURA, Tokyo (JP)

(21) Appl. No.: 16/447,294

(22) Filed: Jun. 20, 2019

(30) Foreign Application Priority Data
Jun. 29, 2018 (JP) 2018-124226

(51) Int. Cl. G06N 20/00; G06N 7/00

(52) U.S. Cl. CPC G06N 20/00; G06N 7/005

(57) ABSTRACT

Provided are a device, a method, and a program which allow learning models to be appropriately evaluated or trained. The evaluation device according to an aspect performs the steps of: (A) obtaining, using checking data, a first execution result based on a first learning model as an exemplar model; (B) obtaining, using the checking data, a second execution result based on a second learning model; (C) determining whether or not the first and second execution results satisfy a logical formula; and (D) comparing, using a Bayesian statistical model checking method, respective behaviors of the first and second learning models with each other on the basis of a result of the determination in the step (C).

### CROSS-REFERENCE TO RELATED APPLICATIONS

The disclosure of Japanese Patent Application No. 2018-124226 filed on Jun. 29, 2018 including the specification, drawings and abstract is incorporated herein by reference in its entirety.

### BACKGROUND

The present disclosure relates to an evaluation method for learning models, a training method, a device, and a program.

Patent Document 1 discloses a method of converting a deep neural network (DNN) having a large footprint to a DNN having a smaller footprint.

### RELATED ART DOCUMENT

### Patent Document

[Patent Document 1] US Patent Application Publication No. 2016/0307095

### SUMMARY

In accordance with Cited Document 1, when an exemplar model and a learning model are given, it is difficult to evaluate whether or not the learning model successfully maintains the behavior of the exemplar model.

Other problems and novel features of the present disclosure will become apparent from a statement in the present specification and the accompanying drawings.

According to an aspect, an evaluation method for learning models determines whether or not the results of executing a first learning model and a second learning model satisfy a logical formula and compares the respective behaviors of the learning models with each other using a Bayesian statistical model checking method.

According to the aspect, it is possible to allow the learning models to be appropriately evaluated or trained.

### BRIEF DESCRIPTION OF THE DRAWINGS

FIG. 1 is a view for illustrating an example of a BSMC method for analog circuits;

FIG. 2 is a flow chart showing a process in the example of the BSMC method for analog circuits;

FIG. 3 is a view for illustrating another example of the BSMC method for analog circuits;

FIG. 4 is a flow chart showing a process in the other example of the BSMC method for analog circuits;

FIG. 5 is a view for illustrating an evaluation device according to a first example of a first embodiment;

FIG. 6 is a view for illustrating an evaluation device according to a second example of the first embodiment;

FIG. 7 is a flow chart showing an example of a process algorithm for the evaluation device shown FIG. 5;

FIG. 8 is a flow chart showing an example of a process algorithm for the evaluation device shown FIG. 6;

FIG. 9 is a view for illustrating an evaluation device according to a first example of a second embodiment;

FIG. 10 is a view for illustrating an evaluation device according to a second example of the second embodiment;

FIG. 11 is a view showing a checking property including second, first, and lower order differences;

FIG. 12 is a view for illustrating a checking property including n-th and lower order differences;

FIG. 13 is a flow chart showing an example of a process algorithm for the evaluation device shown in FIG. 9;

FIG. 14 is a flow chart showing an example of a process algorithm for the evaluation device shown in FIG. 10;

FIG. 15 is a view for illustrating a training device according to a third embodiment;

FIG. 16 is a flow chart showing an example of a training method according to the third embodiment;

FIG. 17 is a flow chart showing a training method which is a combination of the training method shown in FIGS. 15 and 16 and an evaluation method in the first embodiment;

FIG. 18 is a view for illustrating a training device according to a fourth embodiment;

FIG. 19 is a view for illustrating outputs from an exemplar model used in a first modification of the fourth embodiment;

FIG. 20 is a view for illustrating outputs from a training target model used in the first modification;

FIG. 21 is a flow chart showing an example of a training method according to the first modification;

FIG. 22 is a view for illustrating a training device according to a second modification of the fourth embodiment;

FIG. 23 is a flow chart showing an example of a training method according to the second modification;

FIG. 24 is a view for illustrating an evaluation device according to a first example of a fifth embodiment;

FIG. 25 is a view for illustrating an evaluation device according to a second example of the fifth embodiment;

FIG. 26 is a flow chart showing an evaluation method according to a sixth embodiment;

FIG. 27 is a flow chart showing an evaluation method according to a first modification of the sixth embodiment;

FIG. 28 is a view for illustrating a training device according to another embodiment; and

FIG. 29 is a block diagram showing a configuration of the device according to the other embodiment.

### DETAILED DESCRIPTION

For improved clarity of the description, the following description and drawings are omitted and simplified as appropriate. Also, each of the elements shown in the drawings as functional blocks that perform various processes can be configured using a CPU (Central Processing Unit), a memory, or another circuit as hardware, while such an element can be implemented by a program loaded in a memory or the like. Therefore, it is to be understood by those skilled in the art that each of the functional blocks can variously be implemented by hardware only, by software only, or by a combination of hardware and software, and is not limited to any of hardware, software, and a combination thereof. Note that, in the individual drawings, like parts are denoted by like reference numerals, and a repeated description is omitted as necessary. Also, a repeated description of the overlapping contents of individual embodiments is omitted as appropriate. Each of the processes in evaluation methods and training methods which are shown below is performed through the execution of a program by a processor.

The program mentioned above can be stored using various types of non-transitory computer readable media and supplied to a computer. The non-transitory computer readable media include various types of tangible storage media. Examples of the non-transitory computer readable media include a magnetic recording medium (e.g., flexible disk, magnetic tape, or hard disk drive), a photomagnetic recording medium (e.g., photomagnetic disk), a CD-ROM (Read Only Memory), a CD-R, a CD-R/W, and a semiconductor memory (e.g., mask ROM, PROM (Programmable ROM), EPROM (Erasable PROM), flash ROM, or RAM (Random Access Memory)). The program may also be supplied to the computer using various types of transitory computer readable media. Examples of the transitory computer readable media include an electrical signal, an optical signal, and an electromagnetic wave. The transitory computer readable media can supply the program to the computer via a wired communication path such as an electric wire or an optical fiber or a wireless communication path.

When machine learning is used particularly in a method of implementing an intrusion detection filter, it is assumed that, as attacks are more sophisticated, the filter is updated by re-programming (program updating) or the like. In learning from data, it is necessary to check the presence or absence of degradation or the like. However, there is no other clear indicator for checking the presence or absence of degradation but accuracy. For example, when an exemplar model serving as an exemplar (reference) is given, and an improvement model (learning model) which improves the exemplar model is trained, it is difficult to compare the respective behaviors of the exemplar model and the learning model with each other and check the equivalence therebetween. Specifically, the accuracy of a prediction model and the theoretical applicability of the prediction model to a true model serve as comparative indicators for the reference model and the improvement model, and there is no appropriate comparative indicator associated with the behavioral equivalence to the reference model. In addition, a training method which allows the behavior to be held as much as possible has not been proposed yet.

In view of this, the present disclosure provides a comparison method for the learning models. The present disclosure also applies a training method for implementing learning with less degradation to the case where optimization involving re-training is performed. In addition, in a Neural Network (NN), the problem of an Adversarial Example presents a global issue. The present embodiment provides a training method which allows resistance to an adversarial example to be obtained and allows the behavior of the learning model serving as the exemplar to be maintained as much as possible.

For example, to implement an automatic driving technique, a recognition/control model based on machine learning represented by deep learning, an intrusion detection filter against more sophisticated security attacks, and construction and continuous improvement thereof are necessary.

When machine learning is used particularly in a method of implementing an intrusion detection filter, it is assumed that, as attacks are more sophisticated, the filter is updated by re-programming (program updating) or the like. In learning from data, it is necessary to check the presence or absence of degradation or the like. The checking of degradation or the like is also necessary in constructing the recognition/control model. However, in deep learning, there is no other clear indicator for recognizing degradation but accuracy. In sparse statistical machine learning for constructing a statistical model, such as Akaike's information criteria (AIC) or Lasso, sAIC (sparse regression Akaike's information criteria) is proposed. However, each of the AIC and the sAIC is an indicator based on the assumption that there is a true distribution and used to evaluate applicability to the true distribution. In a method for direct comparison between models which is required for continuous improvement, an amount of statistics such as the AIC or the sAIC has fluctuations. Therefore, it is hard to say that the AIC and the sAIC are appropriate indicators.

Accordingly, when the two learning models are compared with each other, a clearer evaluation indicator is necessary. In the present embodiment, as a comparison method for the learning models, a method based on Bayesian statistical model checking (hereinafter referred to as BSMC) is proposed. The comparison method is applicable to various learning models. For example, the comparison method allows the learning models to be compared with each other even when the learning models are trained by any of Unsupervised Learning, Supervised Learning, Semi-Supervised Learning, Reinforcement Learning, or a combination thereof.

On the other hand, a training method which achieves an improvement, while allowing the behavior of an improvement target to be maintained as much as possible is also necessary. Accordingly, the present disclosure proposes a training method for general supervised learning including deep learning and regression.

In a comparison method (evaluation method) for the learning models according to the present embodiment, a match between output traces generated from two models is determined using a BSCM method. In the determination, a logical formula for determining a match between the output sequences is defined in advance. For example, the logical formula is a BLTL (Bounded Linear Temporal Logic) formula. Using the logical formula, bounded model checker (BMC) is performed on the sequences formed by individual output pairs. Then, Bayesian testing is performed on the obtained checker result sequences to compare the learning models with each other. The BSMC used herein is obtained by simplifying those described in Documents [1] and [2] shown below.
[1] Ying-Chih Wang, Anvesh Komuravelli, Paolo Zuliani, and Edmund M. Clarke “Analog Circuit Verification by Statistical Model Checking.” In Proc. of ASP-DAC, pp. 1-6, 2011. http://www.cs.cmu.edu/^{˜}akomurav/publications/analog_smc.pdf
[2] P Zuliani, A Platzer, E M Clarke, “Bayesian statistical model checking with application to Stateflow/Simulink verification,” Formal Methods in System Design, Vol. 43, Issue. 2, pp. 338-367, 2013. http://repository.cmu. edu/cgi/viewcontent.cgi?article=3714&context=compsci

In the case where each of the models is other than a model which has a sequence in which term arrangement is continuous and to which the continuous term arrangement in the sequence is significant, such as clustering or classifier, it can be considered that even this method allows the behavioral equivalence to be checked. By inventively modifying the BLTL method, it is also possible to evaluate the degree of improvement/deterioration. In making the comparison, output sequences can be generated within the framework of cross-validation using checking data given in advance. Instead of using the Monte Carlo approach in the method described in the document, it may also be possible to sample the checking data with replacement and repeatedly use the sampled checking data.

On the other hand, in the case where each of the models is a prediction model such as a regression model or for position estimation, term arrangement in a sequence such as continuous term arrangement in a sequence is significant. In such a case, it is necessary to perform behavioral equivalence checking considering term arrangements in sequences. To perform the checking, it is necessary to define conditions to be satisfied by the relationship between a pair in sequences which is currently subjected to the comparison and the subsequent pair in the sequences. However, in the BSMC method described above, it is necessary to introduce a Next Time Operator X into a BLTL formula. It is theoretically possible to perform checking by introducing the next time operator but, in the present disclosure, the fashion in which output sequences are given is inventively modified to perform behavioral equivalence checking considering term arrangements in the sequences.

It is also possible to extend the method to the case where the length of each of the pair of target sequences is N. In the generation of the output sequences in accordance with the present comparison method, it is possible to sample a checking data set with replacement and repeatedly use the sampled checking data set. By using sampling with replacement instead of the Monte Carlo approach used in the document mentioned above, the probability of the Bayesian testing can be improved. However, it may also be possible to perform the Bayesian testing only on the generation of the output sequences in the cross-validation in the document.

Particularly in the behavioral equivalence checking using the BSMC method described above, the BLTL formula to be used can be described using a subset of the BLTL logic. This can further simplify a process of determining whether or not the output traces of the two learning models satisfy the BLTL formula for checking the behavioral equivalence.

For the training method which allows the behavior to be maintained, the following method can be used. Specifically, a data set is produced by comparing an output from a pre-updating model (exemplar model) with a label and appropriately correcting the output. Then, using the data set as teacher data, the improvement model is trained. Particularly for the correction of labeled data, various methods can be considered. Accordingly, it is also possible to perform comparative checking on learning result models and select an appropriate model.

In the case of using the training method described above, when each of the models is a model which has a sequence in which term arrangement is continuous and to which the continuous term arrangement in the sequence is significant, it is expected that the implementation of training which allows the behavior to be maintained as much as possible is difficult. Accordingly, a training method is proposed in which terms in the sequences are similarly arranged, such as with the relationship between a pair and the subsequent pair in a sequence. In addition, a method obtained by integrating the present training method with the checking method described above is also proposed. In particular, in a deep learning method, the extension of the training method to the case where the length of each of the pair of target sequences is N is also shown.

The training method which allows the behavior of the exemplar model to be maintained includes the items (a) to (d) shown below:

(a) The improvement of learning models such as a security filter resulting from the obtention of new labeled teacher data;

(b) Training involving no change in the labeled teacher data but involving simplification of the learning model and replacement with other simpler learning models;

(c) Integration of the items (a) and (b) shown above. In other words, training which allows new labeled teacher data to be obtained and involves simplification of the learning model and replacement with other simpler learning models; and

(d) Training involving simplification of the learning model and replacement with other simpler learning models to allow resistance to an adversarial example to be obtained particularly in neural network training or the like, while allowing the behavior to be maintained as much as possible.

Note that, in the present disclosure, for ease of description, an example in which models are provided in one-to-one relation is described. For example, for a checking method, an example using one exemplar model and one checking target model is shown. For a training method, an example using one teacher pre-trained model and one student training target model is shown. Needless to say, each of the checking method and the training method is not limited to the one-to-one example and can easily be extended to a one-to-N example, where N is an integer of not less than 2. Accordingly, a method according to the present embodiment is also applicable to a one-to-N evaluation method and to a one-to-N training method.

[First Example of BSMC Method for Analog Circuits]

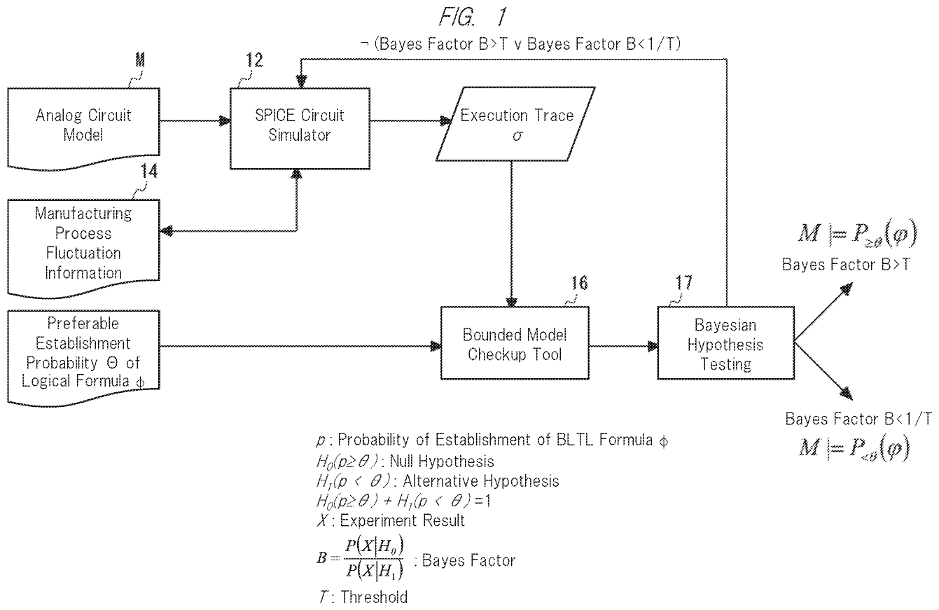

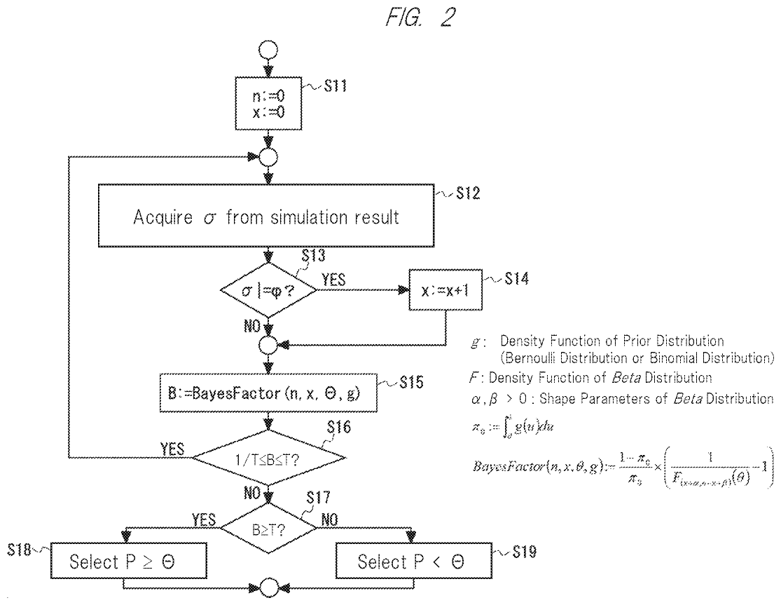

Using FIGS. 1 and 2, a description will be given of a first example of a BSMC method for analog circuits. FIG. 1 is a schematic diagram for illustrating the BSMC method for analog circuits. FIG. 2 is a flow chart showing an algorithm for the BSMC method shown in FIG. 1.

A SPICE circuit simulator 12 performs Monte Carlo simulation using manufacturing process fluctuation information 14 for an analog circuit model M. In a Monte Carlo method, using the manufacturing process fluctuation information as a parameter, a sequence of simulation input data is formed. The SPICE circuit simulator 12 performs circuit simulation for the analog circuit model M using the input data.

Thus, an execution trace σ of the analog circuit model M is acquired. Specifically, output data when the input data is input to the analog circuit model M serves as the execution trace σ. In addition, the property to be satisfied by the analog circuit model M is defined by a logical formula ϕ. The logical formula ϕ is a BLTL formula. A preferable establishment probability Θ of the logical formula ϕ is defined as a determination value.

A bounded model checker tool 16 checks whether or not the execution trace σ satisfies the logical formula ϕ, i.e., whether or not σ|=ϕ is established using BMC (bounded model checker). The bounded model checker tool 16 calculates a Bayes factor B on the basis of the result of the checking. The bounded model checker tool 16 determines whether or not Bayesian hypothetical testing 17 is worth performing on the basis of the Bayes factor B. The Bayesian hypothetical testing 17 is a test for determining whether or not the establishment probability of σ|=ϕ is not less than Θ.

The Monte Carlo simulation is continued until the Bayesian hypothetical testing 17 becomes worth performing, and the SPICE circuit simulator 12 acquires the execution trace σ. The bounded model checker tool 16 checks whether or not σ|=ϕ is established using the BMC. When the Bayesian hypothetical testing becomes worth performing, the Bayesian hypothetical testing 17 is performed.

In the Bayesian hypothetical testing 17, it is determined whether or not the establishment probability of σ|=ϕ is not less than Θ. In other words, it is determined whether or not the probability of satisfying the logical formula ϕ is not less than the determination value Θ. The determination value Θ is the threshold of the probability. Note that M|=P_{≥Θ}(ϕ) means that the probability that the analog circuit model M satisfies the logical formula ϕ is not less than Θ. On the other hand, M|=P≤Θ(ϕ) means that the probability that the analog circuit model M satisfies the logical formula ϕ is less than Θ.

Using 2, a description will be given of the BSMC method for analog circuits shown in FIG. 1. FIG. 2 shows an example of a process algorithm from the acquisition of the execution trace σ to the determination using the Bayesian hypothetical testing 17 in the circuit simulation. It is assumed that p is the establishment probability of σ|=ϕ and Θ is the preferable establishment probability of σ|=ϕ. It is also assumed that g is the density function of a binomial distribution or a Bernoulli distribution and T used in the Bayesian hypothetical testing is a constant of not less than 1.

First, it is assumed that n:=0 and x:=0 are satisfied (S11). Then, the execution trace σ is acquired from the result of the simulation performed by the SPICE circuit simulator 12 to establish n:=n+1 (S12). Specifically, the Monte Carlo simulation using a manufacturing process fluctuation parameter is performed on the analog circuit model M to acquire the execution trace σ. Then, n is incremented.

The bounded model checker tool 16 checks whether or not σ|=ϕ is established using the BMC (S13). Specifically, the bounded model checker tool 16 determines whether or not the execution trace σ satisfies the logical formula ϕ describing the property to be satisfied by the analog circuit model M.

When σ|=ϕ is not established (NO in S13), the process moves to S15. When σ|=ϕ is established (YES in S13), the process establishes x:x+1 (S14) and moves to S15. Then, the process establishes B=BayesFactor(n,x,Θ,g) (S15). In other words, the bounded model checker tool 16 assigns n, x, Θ, and g to the BayesFactor(n,x,Θ,g) to calculate the Bayes factor B. The function BayesFactor(n,x,Θ,g) is as shown in FIG. 2. It is assumed that the shape parameters α and β of a beta distribution are defined in advance.

Next, it is determined whether or not 1/T≤B≤T is satisfied (S16) such that the Bayesian hypothetical testing 17 is performed using the function Bayes factor B. When 1/T≤B≤T is satisfied (YES in S16), the process returns to S12. In other words, when 1/T≤B≤T is satisfied, the Bayesian hypothetical testing 17 is not worth performing so that the Monte Carlo simulation is continued.

When 1/T≤B≤T is not satisfied (NO in S16), the Bayesian hypothetical testing 17 is worth performing so that it is determined whether or not B≥T is satisfied (S17). When B≥T is satisfied (YES in S17), P≥Θ is selected (S18). When B≥T is not satisfied (NO in S17), P<Θ is selected (S19). Thus, the process is ended. As described above, T is a constant of not less than 1.

[Example 2 of BSMC Method for Analog Circuits]

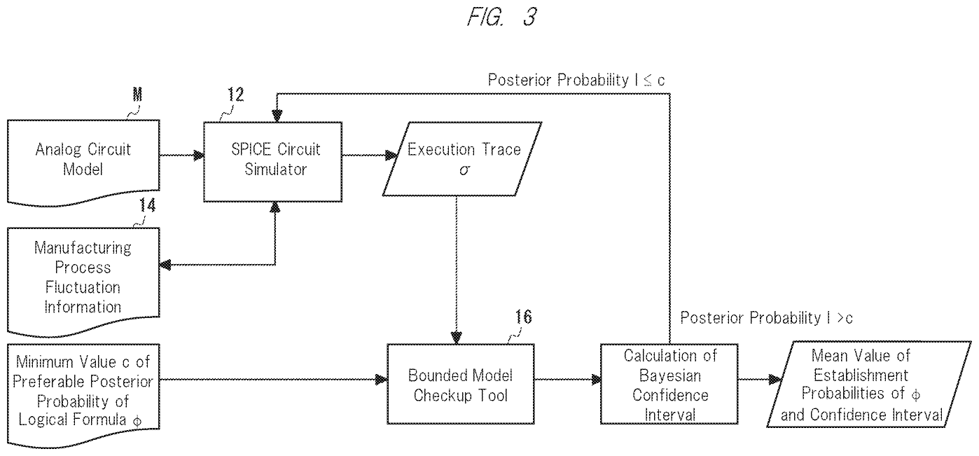

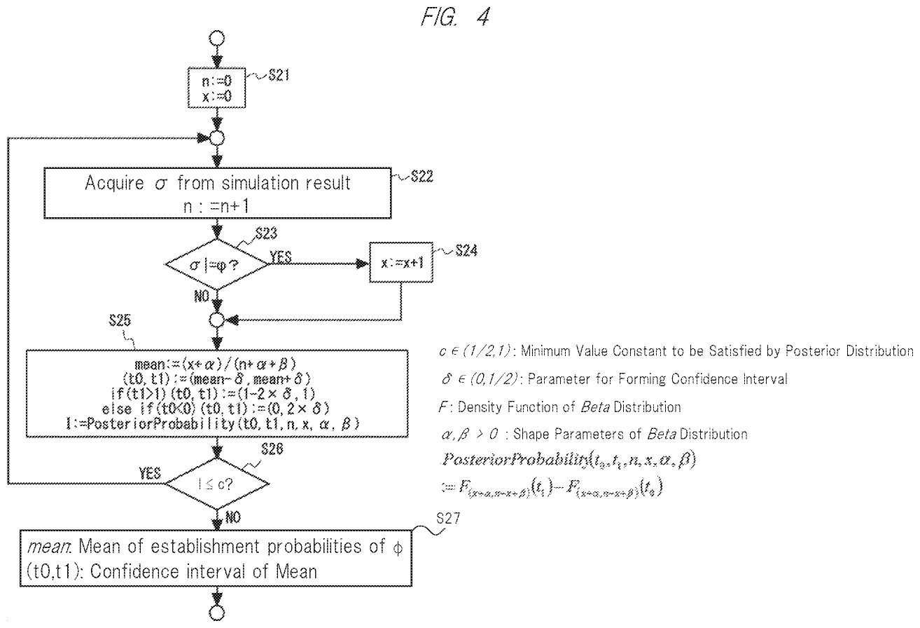

Using FIGS. 3 and 4, a description will be given of a second example of the BSMC method for analog circuits. FIG. 3 is a schematic diagram for illustrating another BSMC method for analog circuits. FIG. 4 is a flow chart showing an example of an algorithm for the BSMC method shown in FIG. 3.

In the same manner as in FIG. 1, the SPICE circuit simulator performs Monte Carlo simulation using manufacturing process fluctuation information 14 for the analog circuit model M. In the Monte Carlo method, using the manufacturing process fluctuation information as a parameter, a sequence of simulation input data is formed. The SPICE circuit simulator 12 uses the input data to perform circuit simulation for the analog circuit model M.

Thus, the execution trace σ of the analog circuit model M is acquired. Specifically, output data when the input data is input to the analog circuit model M serves as the execution trace σ. In addition, the property to be satisfied by the analog circuit model M is defined by the logical formula ϕ. The minimum value of the preferable posterior probability of the establishment of the logical formula ϕ is defined as a determination value c. The determination value c is a constant set in advance.

The bounded model checker tool 16 checks whether or not the execution trace σ satisfies the logical formula ϕ, i.e., whether or not σ|=ϕ is established using the BMC (bounded model checker). The bounded model checker tool 16 calculates a Bayesian posterior probability I on the basis of the result of the checking. The bounded model checker tool 16 calculates a confidence interval including the mean of the probabilities that σ|=ϕ is established. Then, it is determined whether or not the Bayesian posterior probability I calculated from the confidence interval is not less than c. The Monte Carlo simulation is continued until the Bayesian posterior probability I becomes larger than c, and the SPICE circuit simulator 12 acquires the execution trace σ.

The bounded model checker tool 16 checks whether or not σ|=ϕ is established using the BMC. This allows the mean value of the establishment probabilities and the confidence interval thereof to be updated. When the Bayesian posterior probability I exceeds c, the mean value of the establishment probabilities at that time and the Confidence interval thereof are output. Whether or not the preferable establishment probability of σ|=ϕ is satisfied is separately determined herein using the obtained mean value and the obtained confidence interval.

FIG. 4 shows an example of a process algorithm from the acquisition of the execution trace σ to the outputting of the mean value of the probabilities that σ|=ϕ is established and the confidence interval in the circuit simulation. It is assumed that c∈(½,1) is a minimum value constant to be satisfied by the Bayesian posterior probability I and δ∈(0,½) is a parameter forming the confidence interval. It is also assumed that F is the density function of the beta distribution and α and β are positive parameters among the shape parameters of the beta distribution.

First, it is assumed that n:=0 and x:=0 are satisfied (S21). Then, the execution trace σ is acquired from the result of the simulation performed by the SPICE circuit simulator 12 to establish n:=n+1 (S22). Specifically, the Monte Carlo simulation using the manufacturing process fluctuation parameter is performed on the analog circuit model M to acquire the execution trace σ. Then, n is incremented.

The bounded model checker tool 16 checks whether or not σ|=ϕ is established using the BMC (S23). Specifically, the bounded model checker tool 16 determines whether or not the execution trace σ satisfies the logical formula ϕ describing the property to be satisfied by the analog circuit model M.

When σ|=ϕ is not established (NO in S23), the process moves to S25. When σ|=ϕ is established (YES in S23), the process establishes x:x+1 (S24) and moves to S25. Then, the mean value mean, the confidence interval (t0,t1), and the Bayesian posterior probability I are calculated (S25). The mean value mean and the confidence interval (t0,t1) are given by the following expressions.

mean:=(x+α)/(n+α+β)

(t0,t1):=(mean-δ,mean+δ) if 0≤t0\hat{ }t1—1

(1−2×δ,1) if (t1>1)

(0,2×δ) if (t0<0\hat{ }t1≤1)

The Bayesian posterior probability I can be determined by assigning t0, t1, n, x, α, and β to the function PosteriorProbability in FIG. 4.

Then, it is determined whether or not I≤c is satisfied (S26). When I≤c is satisfied (YES in S26), the process returns to S22. When I≤c is not satisfied (NO in S26), the mean value mean and the confidence interval (t0,t1) are output (S27). Thus, the process is ended.

### First Embodiment

### First Example of First Embodiment

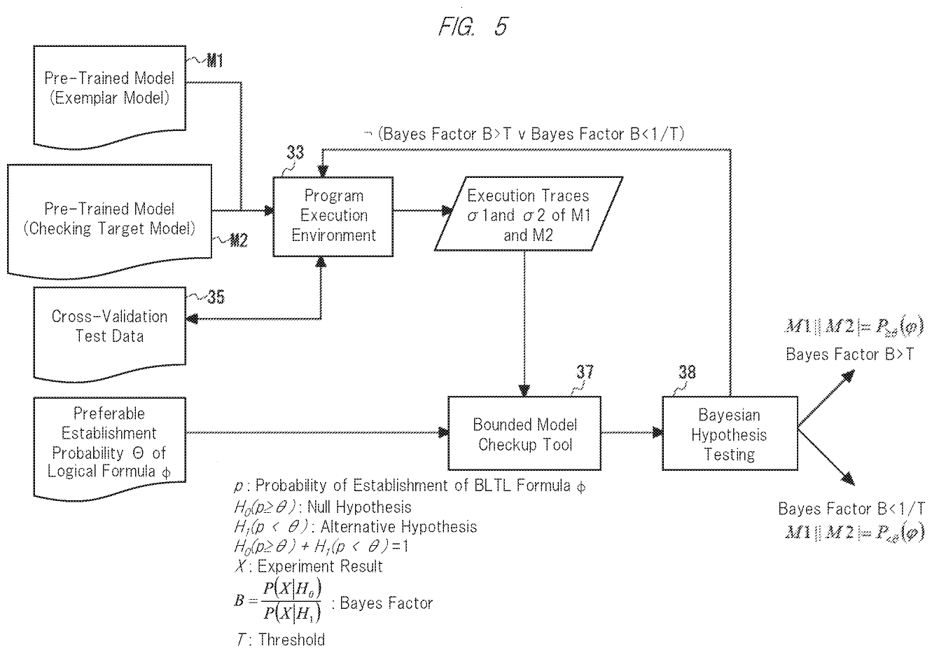

Using FIG. 5, a description will be given of an evaluation device and an evaluation method each according to a first example of a first embodiment. FIG. 5 is a schematic diagram for illustrating the evaluation device according to the first example of the first embodiment. The equivalence between two learning models is evaluated. In FIG. 5, in the same manner as in FIG. 1, the Bayesian hypothetical testing is performed on the basis of the Bayes factor B.

FIG. 5 shows an example in which a pre-trained model M1 (hereinafter referred to as the first learning model M1) is a learning model (exemplar model) serving as an exemplar, while a pre-trained model M2 (hereinafter referred to as the second learning model M2) is an equivalence checking target model.

To a program execution environment 33, cross-validation test data 35 is input. The program execution environment 33 executes, using the test data 35, the respective programs as the first learning model M1 and the second learning model M2. Specifically, the program execution environment 33 executes, using the test data 35 as input data, the first learning model M1 and the second learning model M2 as the programs.

This allows respective execution traces σ1 and σ2 of the first and second learning models M1 and M2 to be acquired. The result of executing the program using the test data 35 serves as the execution trace σ1. The result of second execution using the test data 35 and based on the second learning model M2 serves as an execution trace σ2.

In addition, a property to be satisfied by the first and second learning models M1 and M2 with respect to equivalence is defined in advance by the logical formula ϕ. The logical formula ϕ is described in, e.g., the bounded linear temporal logic (BLTL) formula. The preferable establishment probability of the logical formula ϕ is defined in advance as the determination value Θ. The logical formula ϕ will be descried later.

A bounded model checker tool 37 checks whether or not the execution traces σ1 and σ2 satisfy the logical formula ϕ using the BMC. In other words, the bounded model checker tool 37 checks whether or not σ1∥σ2|=ϕ is established using the BMC. The bounded model checker tool 37 calculates the Bayes factor B on the basis of the result of the checking using the BMC. Note that σ1∥σ2 represents a parallel execution trace including the traces σ1 and σ2.

The bounded model checker tool 37 determines whether or not Bayesian hypothetical testing 38 is worth performing on the basis of the Bayes Factor B. The Bayesian hypothetical testing 38 is a test for determining whether or not the establishment probability of σ1∥σ2|=ϕ is not less than the determination value Θ. The program execution environment 33 acquires the execution traces σ1 and σ2 until the Bayesian hypothetical testing 38 becomes worth performing or until the test data 35 is exhausted. Then, using the BMC, the bounded model checker tool 37 checks whether or not σ1∥σ2|=ϕ is established on the basis of the execution traces σ1 and σ2.

When the Bayes factor B is sufficient to perform the Bayesian hypothetical testing 38 or when the test data 35 is exhausted, the bounded model checker tool 37 performs the Bayesian hypothetical testing 38 to determine whether or not the establishment probability of σ1∥σ2|=ϕ is not less than the determination value Θ. Note that, when the test data 35 is exhausted, the Bayesian hypothetical testing 38 need not be performed. When the Bayes factor B is insufficient to perform the Bayesian hypothetical testing 38, the determination of whether or not the establishment probability of σ1∥σ2|=ϕ is not less than the determination value Θ fails.

Accordingly, it is assumed that the sufficiently long cross-validation test data 35 is prepared in advance. In this case, it is determined that the Bayes factor B is sufficient to perform the Bayesian hypothetical testing 38. The bounded model checker tool 37 determines whether or not the probability that the first and second learning models M1 and M2 satisfy the logical formula ϕ is not less than Θ.

Note that M1∥M2|=P_{≤Θ}(ϕ) means that the probability that the first and second learning models M1 and M2 satisfy the logical formula ϕ is not less than Θ. In other words, the Bayes factor B is larger than T. On the other hand, M1∥M2|=P_{≤Θ}(ϕ) means that the probability that the first and second learning models M1 and M2 satisfy the logical formula ϕ is less than Θ. In other words, the Bayes factor B is smaller than 1/T. Note that T is a constant of not less than 1.

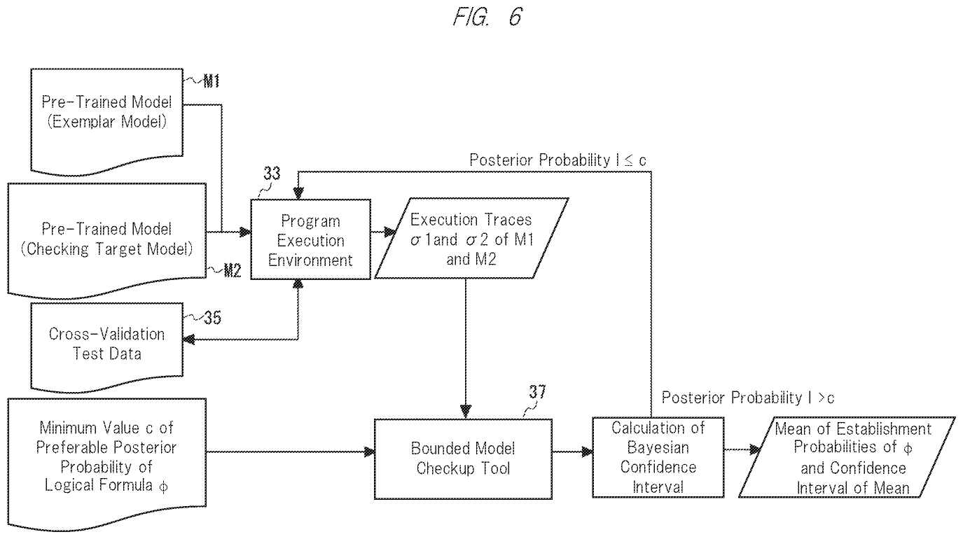

(Second Example of First Embodiment) Using FIG. 6, a description will be given of an evaluation device according to a second example of the first embodiment. FIG. 6 is a view for illustrating an evaluation device according to the second example of the first embodiment. The evaluation device evaluates the equivalence between two learning models. In FIG. 6, in the same manner as in FIG. 3, the confidence interval including the mean of the probabilities that the logical formula ϕ is established is calculated.

Similarly to FIG. 5, FIG. 6 shows an example in which the pre-trained model M1 (referred to as the first learning model M1) is a learning model (exemplar model) serving as an exemplar, while the pre-trained model M2 (referred to as the second learning model M2) is a learning model (target model) serving as an equivalence checking target.

To the program execution environment 33, the cross-validation test data 35 is input. The program execution environment 33 executes the respective programs as the first learning model M1 and the second learning model M2 using the test data 35. Specifically, the program execution environment 33 executes, using the test data 35 as input data, the first learning model M1 and the second learning model M2 as the programs. This allows the respective execution traces σ1 and σ2 of the first and second learning models M1 and M2 to be acquired.

In addition, the property to be satisfied by the first and second learning models M1 and M2 with respect to equivalence is defined in advance by the logical formula ϕ. The logical formula ϕ is described in, e.g., a bounded linear temporal logic (BLTL) formula. An example of the establishment of the logical formula ϕ will be described later. The minimum value of the preferable posterior probability of the establishment of the logical formula ϕ is defined as the determination value c. The determination value c is a constant set in advance.

The bounded model checker tool 37 checks whether or not the execution traces σ1 and σ2 satisfy the logical formula ϕ using the BMC. In other words, the bounded model checker tool 37 checks whether or not σ1∥σ2|=ϕ is established using the BMC. Then, the bounded model checker tool 37 calculates the confidence interval including the mean of the probabilities that σ1∥σ2|=ϕ is established on the basis of the result of the checking using the BMC.

The bounded model checker tool 37 calculates the Bayesian posterior probability I from the confidence interval. The bounded model checker tool 37 determines whether or not the Bayesian posterior probability I is not less than the determination value c. The program execution environment 33 acquires the execution traces σ1 and σ2 until the Bayesian posterior probability I becomes not less than the determination value c or until the test data 35 is exhausted. Specifically, when the Bayesian posterior probability I is less than the determination value c, the program execution environment 33 acquires the execution traces σ1 and σ2 using the next test data 35.

Thus, the bounded model checker tool 37 checks whether or not σ1∥σ2|=ϕ is established using the BMC. The bounded model checker tool 37 calculates the mean value of the establishment probabilities and the confidence interval on the basis of the result of the checking. The bounded model checker tool 37 calculates the Bayesian posterior probability I on the basis of the confidence interval and the like.

When the Bayesian posterior probability I is not less than the determination value c, the bounded model checker tool 37 outputs the mean value of the establishment probabilities and the confidence interval. When the test data 35 is exhausted before the Bayesian posterior probability I becomes not less than the determination value c, the bounded model checker tool 37 outputs the mean value of the establishment probabilities and the confidence interval as reference values. Accordingly, it is assumed that the sufficiently long cross-validation test data is prepared in advance. This allows the mean value of the establishment probabilities and the confidence interval to be output.

When the Bayesian posterior probability I thus exceeds the determination value c, it is possible to obtain the mean value of the establishment probabilities that the first learning model M1 and the second learning model M2 satisfy the logical formula ϕ and the confidence interval thereof. Whether or not the preferable establishment probability of σ1∥σ2|=ϕ is satisfied is separately determined herein using the obtained mean value and the obtained confidence interval. It is appropriate to determine whether or not the mean value and the confidence interval satisfy criteria determined in advance.

Examples 1 to 8 of the logical formula ϕ used to check the behavioral equivalence between the learning models M1 and M2 in the first and second examples of the first embodiment are shown below.

### [Math. 1]

d1(x,y): A loss function formed of any norm such as L1-norm, L2-norm, Lp-norm, or L∞-norm, KL-Divergence (Kullback-Leibler-Divergence), Jensen-Shannon-Divergence, a k-th power error (where k is a real number satisfying k≠0), or the like.
out_o(t):={out_o[1], . . . ,out_o[N]}(t): A t-th output from the first learning model M1 (exemplar model)
out_m(t):={out_m[1], . . . ,out_m[N]}(t): A t-th output from the second learning model M2 (target model)
ok_o(t): A comparison between the t-th output from the exemplar model with a label, where 1 represents a match with the label and 0 represents a mismatch with the label
ok_m(t): A comparison between the t-th output from the target model with the label, where 1 represents a match with the label and 0 represents a mismatch with the label

### Example 1

The checking of behavioral equivalence between the models

Pr_≥Θ[d1(out_o(t),out_m(t))<ε]

# The probability that “the values of each pair of outputs substantially match” is not less than Θ (where ε is a predetermined constant).

### Example 2

The checking of behavioral equivalence between the models with regard to a match/mismatch with the label

Pr_≥Θ[d1(ok_o,ok_m)==0]

# The probability that “correct/wrong answer sequences match” is not less than Θ.

### Example 3

The evaluation of deterioration of the matching of the target model with the label relative to the matching of the exemplar model with the label

Pr≥Θ[ok_o→ok_m]

# The probability that “when the exemplar model matches the label, the changed model also matches the label” is not less than Θ.

### Example 4

The evaluation of improvement of the mismatching of the target model with the label relative to the mismatching of the exemplar model with the label

Pr_<Θ[¬ok_o¬ok_m]

# The probability that “when the exemplar model does not match the label, the changed model also does not match the label” is less than Θ.

### Example 5

The evaluation of improvement of the matching of the target model with the label relative to the matching of the exemplar model with the label

Pr_≥Θ[(ok_o→ok_m)\hat{ }(¬ok_o→ok_m)]

# The probability that “the target model matches the label when the target model should match the label” is not less than Θ.

### Example 6

Evaluation of deterioration of the matching of the target model with the label relative to the matching of the exemplar model with the label

Pr_≥Θ[(ok_o→¬ok_m)\hat{ }(¬ok_o→ok_m)]

# The probability that the target model does not match the label when the target model should match the label” is not more than Θ.

### Example 7

Evaluation of deterioration of behavior when the exemplar model matches the label

Pr_≥Θ[(ok_o→d1(out_o,out_m)<ε]

# The probability that “the values of each pair of outputs substantially match when the exemplar model matches the label” is not less than Θ.

### Example 8

Evaluation of improvement of behavior when the exemplar model does not match the label

Pr_<Θ[ok¬_o→d1(out_o,out_m)<ε]

# The probability that “the values of each pair of outputs substantially math when the exemplar model cannot sense/recognize” is less than Θ.

In the first or second example of the first embodiment, any of the logical formulae ϕ in Examples 1 to 8 shown above can be used. The property formulae enclosed in the brackets of Examples 1 to 8 are not limited to those shown above and may also form propositional logical formulae using the signs shown above.

A BSMC method intended for an analog circuit model as shown in FIG. 1 or 3 uses a general BLTL formula. Accordingly, to check whether or not the acquired execution trace σ satisfies the logical formula (checking property) ϕ, i.e., whether or not σ|=ϕ is satisfied, the bounded model checker (BMC) intended for the BLTL is used. By contrast, in the method according to the first embodiment, as in each of the properties shown in Examples 1 to 8, a BLTL formula formed only of a logical formula not using a time-phase operator can be used. Accordingly, the method according to the first embodiment can be simplified as the following operation.

Step 1. Acquire the execution traces σ1 and σ2 required by the logical formula, i.e., an output from the first learning model M1 and an output from the second learning model M2 at a time t.
Step 2. Assign the acquired values to a propositional logical formula. When the propositional formula is true, return YES. When the propositional formula is false, return NO.

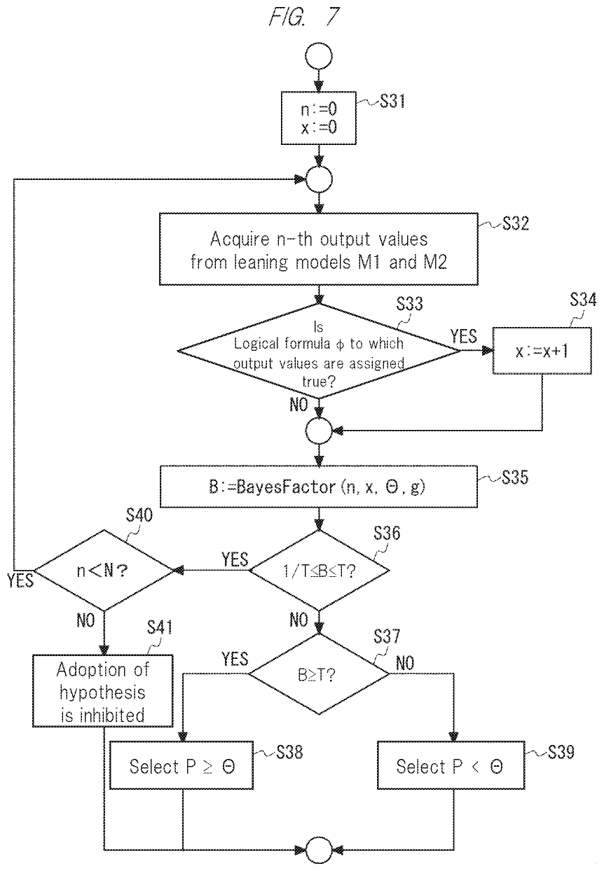

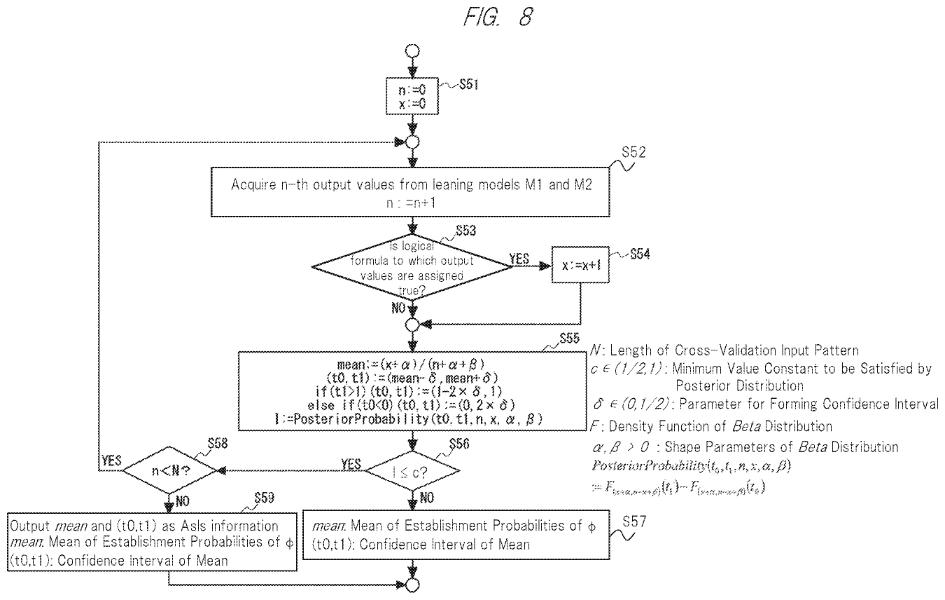

It is assumed herein that the head of an output sequence of each of the learning models corresponds to a time 0 and the last time therein is T. The processes obtained by making the correction described above on the processes shown in FIGS. 2 and 4 are shown in FIGS. 7 and 8.

FIG. 7 is a flow chart showing an example of a process algorithm for the evaluation device shown in FIG. 5. FIG. 7 shows the process algorithm from the acquisition of the pre-trained model execution traces σ1 and σ2 to the determination in the Bayesian hypothetical testing 38.

It is assumed that the length of the cross-validation input pattern (test data 35) is N. It is also assumed that p is the establishment probability of σ1∥σ2|=ϕ, and the determination value Θ is the preferable establishment probability of σ1∥σ2|=ϕ. It is also assumed that g is the density function of the binominal distribution or the Bernoulli distribution, and T used in the Bayesian hypothetical checking (Bayesian hypothetical testing) is a constant of not less than 1.

First, it is assumed that n:=0 and x:=0 are satisfied (S31). The n-th output values among the output values (execution traces σ1 and σ2) obtained by executing the first and second learning models M1 and M2 are acquired, and n:=n+1 is implemented (S32). It is assumed herein that each of the sequences of the output values begins at the 0-th term.

It is determined whether or not the logical formula ϕ to which the output values are assigned is true (S33). Specifically, it is determined whether or not the n-th output values from the first and second learning models M1 and M2 satisfy the logical formula ϕ. In other words, it is checked whether or not σ1∥σ2|=ϕ is satisfied in the n-th output values.

When the logical formula ϕ is true (YES in S33), x:=x+1 is implemented (S34), and then the process moves to S35. When the logical formula ϕ is false (NO in S33), the process moves to S35.

Next, the bounded model checker tool 37 establishes Bayes Factor B=BayesFactor(n,x,Θ,g) (S35). Specifically, the bounded model checker tool 37 assigns n, x, Θ, and g to the function BayesFactor(n,x,Θ,g) to calculate the Bayes factor B. The function BayesFactor(n,x,Θ,g) is as follows. Note that the shape parameters α and β of the beta distribution are defined in advance.

$$\text{N: The length of a cross-validation input pattern} \\ \text{g: The density function of a prior distribution (Bernoulli distribution or binominal distribution)} \\ \text{F: The density function of a beta distribution} \\ \text{α, β > 0: The shape parameters of the beta distribution} \\ {π}_{0} := {\int }_{θ}^{1} g ( u ) du \\ BayesFactor ( n , x , θ , g ) := \frac{1 - {π}_{0}}{{π}_{0}} \times ( \frac{1}{{F}_{( x + α , n - x + β )} ( θ )} - 1 ) \qquad [ Math . 2 ]$$

Next, it is determined whether or not 1/T≤B≤T is satisfied so as to allow the Bayesian hypothetical testing to be performed using the Bayes factor B (S36). When 1/T≤B≤T is satisfied (YES in S36), it is determined whether or not n<N is satisfied (S40). Specifically, when 1/T≤B≤T is satisfied, the Bayesian hypothetical testing is not worth performing so that it is determined whether or not the test data 35 is exhausted. When n<N is satisfied (YES in S40), the process returns to S32. In other words, since the test data S35 is not exhausted, using the next test data 35, the program execution environment 33 executes the learning models M1 and M2 as the programs.

When n<N is not satisfied (NO in S40), the test data 35 is exhausted so that the adoption of a hypothesis is inhibited (S41). In other words, the process is ended on the assumption that whether the establishment probability p is either not less than Θ or less than Θ cannot be determined.

When 1/T≤B≤T is not satisfied (NO in S36), it is determined whether or not B≥T is satisfied. (S37) In other words, it is determined whether or not the establishment probability p is not less than Θ. When B≥T is satisfied (YES in S37), the establishment probability p is not less than Θ so that P≥Θ is selected (S38). When B≥T is not satisfied (NO in S37), the establishment property p is less than Θ so that P<Θ is selected (S39). Thus, the process is ended.

FIG. 8 is a flow chart showing an example of a process algorithm for the evaluation device shown in FIG. 6. FIG. 8 shows the process algorithm from the acquisition of the execution traces σ1 and σ2 of the learning models M1 and M2 to the outputting of the mean value of the establishment probabilities p and the confidence interval.

It is assumed that N is the length of the cross-validation input pattern (test data 35). It is also assumed that c∈(½,1) is a minimum value constant to be satisfied by the posterior distribution, δ∈(0,½) is a parameter forming the confidence interval, F is the density function of the beta distribution, and α and β, are the positive parameter constants of the shape parameters of the beta distribution.

First, it is assumed that n:=0 and x:=0 are satisfied (S51). Then, the n-th output values among the output values (execution traces σ1 and σ2) obtained by executing the first and second learning models M1 and M2 are acquired, and n:=n+l is implemented (S52). It is assumed herein that each of the sequences of the output values begins at the 0-th term.

It is determined whether or not the logical formula ϕ to which the output values are assigned is true (S53). Specifically, it is determined whether or not the n-th output values satisfy the logical formula ϕ. In other words, it is checked whether or not of σ1∥σ2|=ϕ is satisfied in the n-th output values.

When the logical formula ϕ is true (YES in S53), x:=x+1 is implemented (S54), and then the process moves to S55. When the logical formula ϕ is false (NO in S53), the process moves to S55.

Next, the mean value mean, the confidence interval (t0,t1), and the Bayesian posterior probability I are calculated (S55). The mean value mean and the confidence interval (t0,t1) are given by the following expressions:

mean:=(x+α)/(n+α+β)

(t0,t1):=(mean-δ,mean+δ) if 0≤t0\hat{ }t1—1

(1−2×δ,1) if (t1>1)

(0,2×δ) if (t0<0\hat{ }t1≤1)

The Bayesian posterior probability I is determined by assigning t0, t1, n, x, α, β to the function PosteriorProability in FIG. 8.

Next, it is determined whether or not I≤c is satisfied (S56). When I≤c is satisfied (YES in S56), it is determined whether or not n<N is satisfied (S58). When I≤c is satisfied, it is determined whether or not the test data 35 is exhausted. When n<N is satisfied (YES in S58), the process returns to S52. In other words, since the test data 35 is not exhausted, using the next test data 35, the learning models M1 and M2 as the programs are executed.

When n<N is not satisfied (NO in S58), the mean value mean and the confidence interval (t0,t1) are output as reference information. In this case, the mean value mean and the confidence interval (t0,t1) do not result from the use of the sufficient test data 35 and therefore serve as the reference values.

When I≤c is not satisfied (NO in S56), the mean value mean and the confidence interval (t0,t1) are output (S57). Thus, the process is ended.

Note that, e.g., δ:=1.96×(σ\hat{ }2/n)\hat{ }(½) and σ:=α×β{(α+β+1)×(α+β)\hat{ }2} may also be implemented.

According to the present embodiment, it is possible to compare the respective behaviors of the two models which cannot be discriminated from each other by merely using the accuracies of the learning models and an information criterion. This allows the learning models to be appropriately evaluated.

A statistical model checking method intended for checking the property of an analog circuit can be applied to showing an example of a property description using a bounded linear temporal logical formula and to checking the behavioral equivalence between the pre-trained models. At this time, an input pattern serves as cross-validation test data and has a finite length. Accordingly, by adding a process when the pattern length of the test data is insufficient, the statistical model checking method can be applied to evaluation.

To check the behavioral equivalence, a property description using the propositional logical formula is sufficient. Accordingly, by reducing the bounded model checker method to satisfiability determination performed by assigning values to the propositional logical formula, the statistical model checking method can be simplified. In other words, the bounded model checker tool 37 can be simplified. This allows the checking of behavioral equivalence to be implemented on a large amount of cross-validation test data in a realistic period of time.

A training device according to the present embodiment may also perform the following steps (A) to (D) of:

(A) obtaining, using checking data, a first execution result based on a first learning model as an exemplar model;

(B) obtaining, using the checking data, a second execution result based on a second learning model;

(C) determining whether or not the first and second execution results satisfy a logical formula; and

(D) comparing, using a Bayesian statistical model checking method, respective behaviors of the first and second learning models with each other on the basis of a result of the determination in the step (C).

It is possible to evaluate whether or not the second learning model as the target successfully maintains the behavioral equivalence to the first learning model as the exemplar model. Accordingly, when, e.g., the exemplar model is replaced with the target model having a footprint smaller than that of the exemplar model, it is possible to determine whether or not the target model maintains the behavior of the exemplar model.

In the first example, in the step (D), the training device calculates the Bayes factor for a hypothesis associated with the establishment probability of the logical formula and performs the Bayesian hypothetical testing for determining whether or not the establishment probability is not less than the probability threshold. In addition, the training device evaluates the behavioral equivalence between the first learning model and the second learning model on the basis of the result of the Bayesian hypothetical testing. This allows simple and appropriate evaluation to be performed.

In the second example, in the step (D), the training device calculates the confidence interval satisfying the establishment probability of the logical formula, calculates the posterior probability on the basis of the confidence interval, and evaluates the behavioral equivalence between the first learning model and the second learning model on the basis of the posterior probability. This allows simple and appropriate evaluation to be performed.

### Second Embodiment

### First Example of Second Embodiment

The first embodiment has not handled especially smoothness in the behaviors of the pre-trained models, i.e., the behavioral equivalence between differences in output sequences. Accordingly, in a second embodiment, a description will be given of a behavioral equivalence checking method considering the differences in the output sequences. Note that a description of the same content as that described above may be omitted as appropriate.

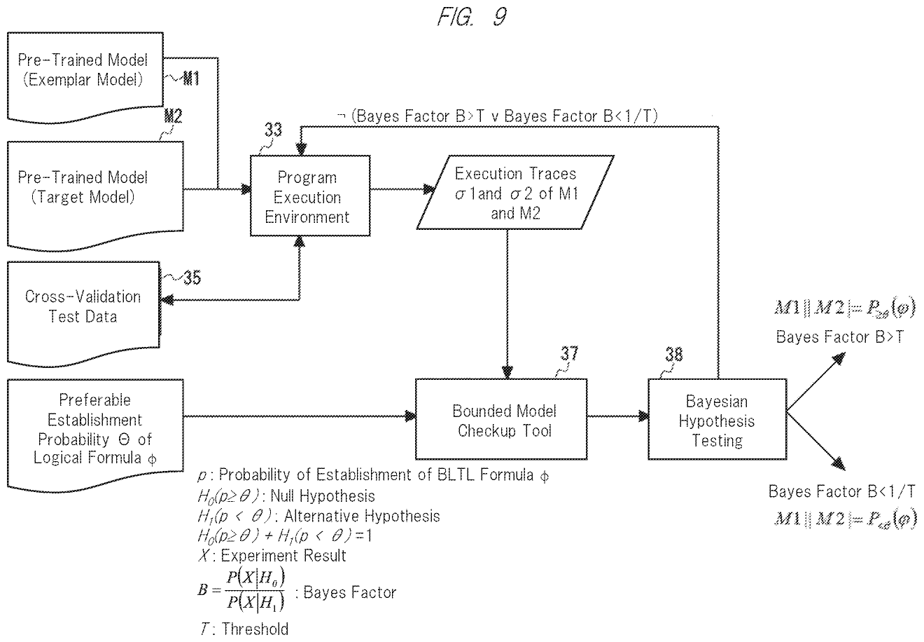

FIG. 9 is a view showing an evaluation device according to a first example of the second embodiment. The evaluation device in FIG. 9 evaluates the behavioral equivalence between the two pre-trained models M1 and M2 (hereinafter referred to as the first learning model M1 and the second learning model M2). The evaluation device in FIG. 9 evaluates the respective behaviors of the first and second learning models M1 and M2 using a BSMC method. The first learning model M1 is a program serving as an exemplar model. The second learning model M2 is a program serving as a checking target model.

To the program execution environment 33, the cross-validation test data 35 is input. The program execution environment 33 executes, using the test data 35, the respective programs as the first learning model M1 and the second learning model M2. Specifically, the program execution environment 33 executes, using the test data 35 as input data, the first learning model M1 and the second learning model M2 as the programs. This allows the respective execution traces σ1 and σ2 of the first and second learning models M1 and M2 to be acquired.

In addition, a property to be satisfied by the first and second learning models M1 and M2 with respect to equivalence is defined in advance by the logical formula ϕ. The logical formula ϕ is described in, e.g., a bounded linear temporal logic (BLTL) formula. The preferable establishment probability of the logical formula ϕ is defined in advance as the determination value Θ. The logical formula ϕ will be descried later.

The bounded model checker tool 37 checks whether or not the execution traces σ1 and σ2 satisfy the logical formula ϕ using BMC. In other words, the bounded model checker tool 37 checks whether or not σ1∥σ2|=ϕ is established using the BMC. The logical formula ϕ is described in, e.g., a bounded linear temporal logic (BLTL) formula. The preferable establishment probability of the logical formula ϕ is defined in advance as the determination value Θ. The logical formula ϕ will be descried later.

The bounded model checker tool 37 calculates the Bayes factor B on the basis of the result of the checking using the BMC. The bounded model checker tool 37 determines whether or not the Bayesian hypothetical testing 38 is worth performing on the basis of the Bayes Factor B. The Bayesian hypothetical testing 38 is a test for determining whether or not the establishment probability of σ1∥σ2|=ϕ is not less than the determination value Θ.

In the second embodiment, unlike in the first embodiment, input data can be formed by performing random sampling with replacement on the cross-validation test data 35 until the Bayesian hypothetical testing 38 becomes worth performing. Specifically, by changing the order of data items in the test data 35, the input data can sequentially be generated. Then, by using the test data 35 as the input data, the program execution environment 33 acquires the execution traces σ1 and σ2. Accordingly, in the present embodiment, the Bayesian hypothetical testing 38 can be performed without exhaustion of the input data. In the Bayesian hypothetical testing 38, it is determined whether or not the establishment probability of σ1∥σ2|=ϕ is not less than the determination value Θ.

Note that M1∥M2|=P_{≥Θ}(ϕ) means that the probability that the first learning model M1 and the second learning model M2 satisfy the logical formula ϕ is not less than Θ. On the other hand, M1∥M2|=P_{≥Θ}(ϕ) means that the probability that the first learning model M1 and the second learning model M2 satisfy the logical formula ϕ is less than Θ.

### Second Example of Second Embodiment

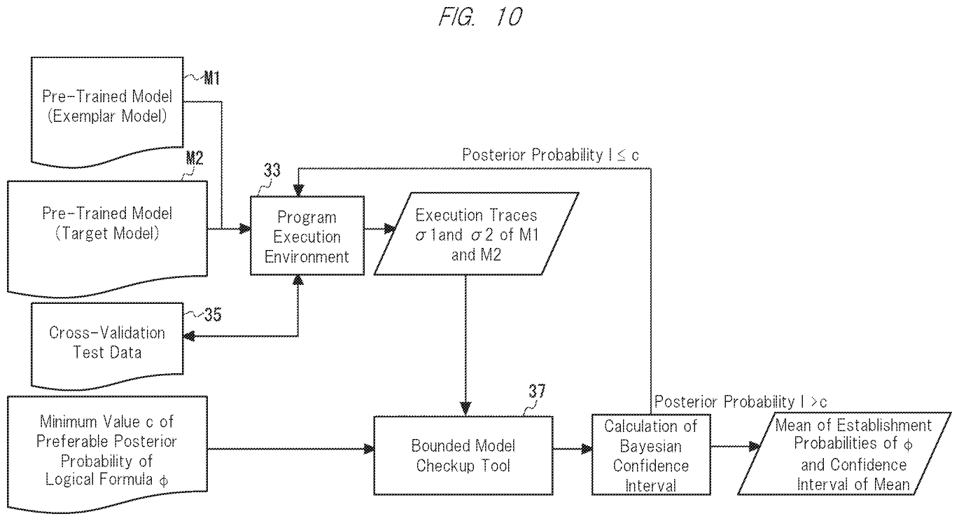

Using FIG. 10, a description will be given of an evaluation device according to a second example of the second embodiment. FIG. 10 is a schematic diagram for illustrating the evaluation device according to the second example of the second embodiment. The evaluation device evaluates equivalence between two learning models. In FIG. 10, as shown in FIG. 6, a confidence interval including the mean of the probabilities that ϕ is established is calculated.

Similarly to FIG. 9 showing the first example, FIG. 10 shows an example in which the pre-trained model M1 (referred to as the first learning model M1) is a learning model (exemplar model) serving as an exemplar, while the pre-trained model M2 (referred to as the second learning model M2) is an equivalence checking target model.

To the program execution environment 33, the cross-validation test data 35 is input. The program execution environment 33 executes, using the test data 35, the respective programs as the first learning model M1 and the second learning model M2. Specifically, the program execution environment 33 executes, using the test data 35 as input data, the first learning model M1 and the second learning model M2 as the programs. This allows the respective execution traces σ1 and σ2 of the first and second learning models M1 and M2 to be acquired.

In addition, a property to be satisfied by the first and second learning models M1 and M2 with respect to equivalence is defined in advance by the logical formula ϕ. The logical formula ϕ is described in, e.g., a bounded linear temporal logic (BLTL) formula. An example of the logical formula ϕ will be described later. The minimum value of the preferable posterior probability of the establishment of the logical formula ϕ is defined as the determination value c. The determination value c is a constant set in advance.

The bounded model checker tool 37 checks whether or not the execution traces σ1 and σ2 satisfy the logical formula ϕ using BMC. In other words, the bounded model checker tool 37 checks whether or not σ1∥σ2|=ϕ is established using the BMC. Then, the bounded model checker tool 37 calculates the confidence interval including the mean value of the probabilities that σ1∥σ2|=ϕ is established on the basis of the result of the checking using the BMC.

The bounded model checker tool 37 calculates the Bayesian posterior probability I from the confidence interval. The bounded model checker tool 37 determines whether or not the Bayesian posterior priority I is not less than the determination value c. The program execution environment 33 acquires the execution traces σ1 and σ2 until the Bayesian posterior priority I becomes not less than the determination value c. In other words, when the Bayesian posterior priority I is less than the determination value c, the program execution environment 33 acquires the execution traces σ1 and σ2 using the next test data 35.

The bounded model checker tool 37 checks whether or not σ1∥σ2|=ϕ is established using the BMC. The bounded model checker tool 37 calculates the mean value of the establishment probabilities and the confidence interval on the basis of the result of the checking.

When the Bayesian posterior probability I is not less than the determination value c, the bounded model checker tool 37 outputs the mean value of the establishment probabilities and the confidence interval. Unlike in the first embodiment, in the present second embodiment, the input data is formed by random sampling with replacement performed on the cross-validation test data 35 until the Bayesian posterior probability I becomes not less than the determination value c. Specifically, by changing the order of data items in the test data 35, the input data can sequentially be generated. Then, by using the test data 35 as the input data, the program execution environment 33 acquires the execution traces σ1 and σ2. Accordingly, in the present embodiment, the mean value of the establishment probabilities and the confidence interval can be outputted without exhaustion of the input data.

Thus, the mean value of the establishment probabilities that the first and second learning models M1 and M2 satisfy the logical formula ϕ and the confidence interval thereof can be obtained. Whether or not the preferable establishment probability of σ1∥σ2|=ϕ is satisfied is separately determined herein using the obtained mean value and the obtained confidence interval.

Examples 9 to 12 of the logical formula ϕ used for behavioral equivalence checking considering the smoothness of the learning models in the first and second examples of the second embodiment are shown below.

### [Math. 3]

d1(x,y), . . . , dn+1(x,y): A loss function formed of any norm such as L1-norm, L2-norm, Lp-norm, or L∞-norm, KL-Divergence (Kullback-Leibler-Divergence), Jensen-Shannon-Divergence, a k-th power error (where k is a real number satisfying k≠0), or the like, where d1, . . . ,dn+1 may be either the same or different out_o(t):={out_o[1], . . . ,out_o[N]}(t): A t-th output from the first learning model M1 (exemplar model)
out_m(t):={out_m[1], . . . ,out_m[N]}(t): A t-th output from the second learning model M2 (target model)
ok_o(t): A comparison between the t-th output from the exemplar model and a label, where 1 represents a match with the label and 0 represents a mismatch with the label
ok_m(t): A comparison between the t-th output from the target model and the label, where 1 represents a match with the label and 0 represents a mismatch with the label
Hereinafter, n X's represented by X . . . X are referred to as Xn or the like. An equivalence checking property considering n-th and lower order differences can also be defined

### Example 9

The checking of behavioral equivalence between the models: considering first and lower order differences in value output sequences

Pr_≥Θ[d1(out_o,out_m)<ε

\hat{ }d2(d1(X(out_o),out_o),d1(X(out_m),(out_m))<ε]

# The probability that “the transition sequences of the values of each pair of outputs substantially match” is not less than Θ.

### Example 10

The checking of behavioral equivalence between the models: considering second and lower order differences in the value output sequences

Pr_≥Θ[d1(out_o,out_m)<ε

\hat{ }d2(d1(X(out_o),out_o),d1(X(out_m),(out_m))<ε]

# The probability that “the transition sequences of the values of each pair of outputs substantially match” is not less than Θ.

### Example 11

The checking of behavioral equivalence between the models with regard to a match/mismatch with the label: considering first and lower order differences in the value output sequences

Pr_≥Θ[d1(ok_o,ok_m)==0

\hat{ }d2(d1(X(ok_o),ok_o),d1(X(ok_m),ok_m))==0]

# The probability that “correct/wrong answer transition sequences match” is not less than Θ.

### Example 12

The checking of behavioral equivalence between the models with regard to a match/mismatch with the label: considering second and lower order differences in the value output sequences

Pr_≥Θ[d1(ok_o,ok_m)==0

\hat{ }d2(d1(X(ok_o),ok_o),d1(X(ok_m),ok_m))==0]

# The probability that “correct/wrong answer transition sequences match” is not less than Θ.

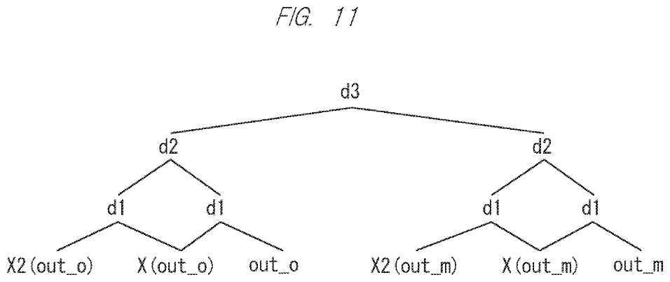

Note that X is a next time operator. X2 is a second time operator to which X is applied twice (X·X). Xn is an n-th time operator to which X is applied n times. d2 is a first order difference in output value sequences, while d3 is a second order difference in the output value sequences. FIG. 11 shows the graphic representation of d1 to d3. The first order difference d2 can be determined from two consecutive output values d0. The second-order difference d3 can be determined from two consecutive first order differences d2. Examples 9 to 12 give consideration to the first and higher order differences in the output value sequences.

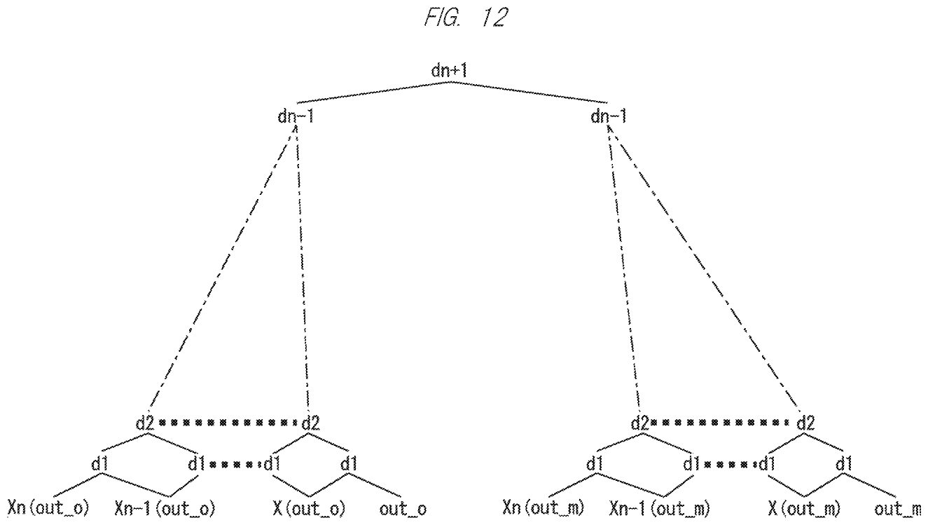

In the logical formulae ϕ in Examples 9 to 12, d1, d2, or d3 is used, but it is also possible to use an n-th (where n is an arbitrary integer of not less than 1) order difference. It is sufficient to use one or more of the n-th and lower order differences. FIG. 12 shows the graphic representation of an example of a checking property considering the n-th and lower order differences. The n-th order difference is obtained by coupling together all the n-th and lower order differences including a 0-th order difference using \hat{ }. An equivalence checking property for determining a match/mismatch with the label considering the n-th and lower order differences can also be defined.

Note that d1 to dn+1 may be either the same or different. For example, it may also be possible that d1 is an L1-norm, d2 is an L2-norm, and so forth. Alternatively, it may also be possible that each of d1 to dn+1 is an Lp-norm.

A property formula enclosed in the brackets 11 such as seen in a BLTL formula Pr≥Θ[ ] is not limited to those in Examples 9 to 12 shown above. It may also be possible to form, as the property formula enclosed in the brackets [ ], a propositional logical formula using terms obtained by the action of the next time operator X on the signs and outputs shown above any number of times not less than 0 times.

The method in which the BSMC is applied to an analog circuit cannot directly use a BLTL formula including the next time operator X. Accordingly, in the behavioral equivalence checking according to the present embodiment, to allow the properties shown in Examples 9 to 12 to be used, the maximum value of k in the k-th time operator Xk included in the BLTL formula is identified. Then, outputs during the period from the time t to a time (t+k) are acquired as time advances. By handling the BLTL formula as a BLTL formula formed only of a logical formula not using a time-phase operator, the determination of whether or not σ1∥σ2|=ϕ is satisfied is made. This operation can be defined as the following operation.

Step 1. Determine the maximum k in Xk included in the logical formula and assume that the maximum k is K.
Step 2. Acquire the execution traces σ1 and σ2 required by the logical formula, i.e., outputs from the first learning model M1 and outputs from the second learning model M2 which correspond to all the times from the time t to the time (t+k).
Step 3. Assign the acquired output values to the logical formula. When the logical formula is true, return Yes. When the logical formula is false, return No.

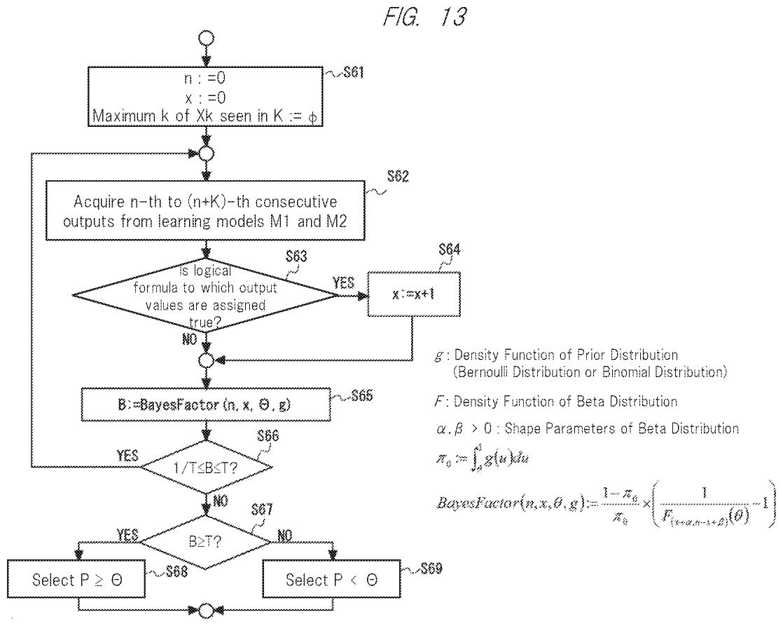

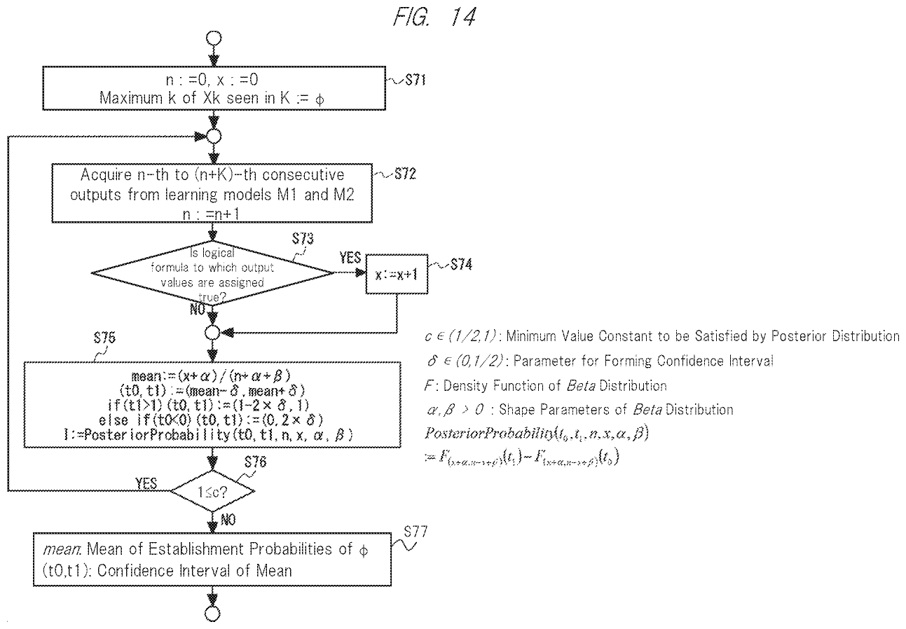

It is assumed herein that the head of an output sequence of each of the learning models corresponds the time 0. The processes obtained by making the correction described above on the processes shown in FIGS. 9 and 10 are shown in FIGS. 13 and 14.

FIG. 13 is a flow chart showing an example of the BSMC method for the first and second learning models shown in FIG. 9. FIG. 13 particularly shows a process from the acquisition of the execution traces σ1 and σ2 to the determination in the Bayesian hypothetical testing.

It is assumed that p is the establishment probability of σ1∥σ2|=ϕ, and 8 is the preferable establishment probability of σ1∥σ2|=ϕ. It is also assumed that g is the density function of a binominal distribution or a Bernoulli distribution, and T used in the Bayesian hypothetical checking is a constant of not less than 1.

It is assumed that n:=0 and x:=0 are satisfied, and K is the maximum k in Xk seen in the logical formula ϕ(S61). The n-th to (n+K)-th consecutive output values from the learning models M1 and M2 are acquired, and n:=n+l is implemented (S62). In other words, the first and second learning models M1 and M2 are executed to acquire the execution traces σ1 and σ2. Then, n-th to (n+K)-th output values in the execution traces σ1 and σ2 are sequentially acquired. It is assumed herein that each of the sequences of the output values begins at the 0-th term. When the cross-validation test data 35 is exhausted, input data can be formed by performing random sampling without replacement on the test data 35.

The bounded model checker tool 37 determines whether or not the logical formula ϕ to which the output values are assigned is true (S63). Specifically, the bounded model checker tool 37 checks whether or not σ1∥σ2|=ϕ is satisfied. When the logical formula ϕ is satisfied (YES in S63), x:=x+1 is implemented (S64), and then the process moves to S65. When the logical formula ϕ is not satisfied (NO in S63), the process moves to S65.

Next, the bounded model checker tool 37 establishes Bayes factor B=BayesFactor(n,x,Θ,g) (S65). Specifically, the bounded model checker tool 37 assigns n, x, Θ, and g to the function BayesFactor(n,x,Θ,g) to calculate the Bayes factor B. The function BayesFactor(n,x,Θ,g) is as shown in FIG. 13. Note that the shape parameters α and β of the beta distribution are defined in advance.

Next, the bounded model checker tool 37 determines whether or not 1/T≤B≤T is satisfied so as to allow the Bayesian hypothetical testing to be performed using the Bayes factor B (S66). When 1/T≤B≥T is satisfied (YES in S66), the process returns to S62. Specifically, using the input data formed by performing the random sampling with replacement on the test data 35, the program execution environment 33 executes the learning models M1 and M2 as the programs. Then, the process described above is repeated.

When 1/T≤B≤T is not satisfied (NO in S66), it is determined whether or not B≥T is satisfied (S67). In other words, it is determined whether or not the establishment probability p is not less than Θ. When B≥T is satisfied (YES in S67), the establishment probability p is not less than Θ so that P≥Θ is selected (S68). When B≥T is not satisfied (NO in S67), the establishment property p is less than Θ so that P<Θ is selected (S69).

FIG. 14 is a flow chart showing an example of the BSMC method for the first and second learning models shown in FIG. 10. FIG. 14 shows the process algorithm from the acquisition of the execution traces σ1 and σ2 of the learning models M1 and M2 to the outputting of the mean value of the establishment probabilities p and the confidence interval.

It is assumed that c∈(½,1) is a minimum value constant to be satisfied by a posterior distribution I, δ ∈ (0,½) is a parameter forming the confidence interval, F is the density function of the beta distribution, and α and β are the positive parameter constants of the shape parameters of the beta distribution.

First, it is assumed that n:=0 and x:=0 are satisfied, and K is the maximum k in Xk seen in the logical formula ϕ(S71). Then, the n-th to (n+K)-th consecutive output values among the output values (execution traces σ1 and σ2) obtained by executing the first and second learning models M1 and M2 are acquired, and n:=n+1 is implemented (S72). It is assumed herein that each of the sequences of the output values begins at the 0-th term. When the cross-validation test data 35 is exhausted, input data can be formed by performing random sampling without replacement on the test data 35.

It is determined whether or not the logical formula ϕ to which the output values are assigned is true (S73). Specifically, the bounded model checker tool 37 checks whether or not σ1∥σ2|=ϕ is satisfied. When the logical formula ϕ is satisfied (YES in S73), x:=x+1 is implemented (S74), and then the process moves to S75. When the logical formula ϕ is not satisfied (NO in S73), the process moves to S75.

Next, the mean value mean, the confidence interval (t0,t1), and the Bayesian posterior probability I are calculated (S75). The mean value mean and the confidence interval (t0,t1) are given by the following expressions:

mean:=(x+α)/(n+α+β)

(t0,t1):=(mean-δ,mean+δ) if 0≤t0\hat{ }t1—1

(1−2×δ,1) if (t1>1)

(0,2×δ) if (t0<0\hat{ }t1≤1)

The Bayesian posterior probability I is determined by assigning t0, t1, n, x, α, β to the function PosteriorProability in FIG. 14.

Next, it is determined whether or not I≤c is satisfied (S76). When I≤c is satisfied (YES in S76), the process returns to S72. Using the input data formed by performing random sampling with replacement on the test data 35, the learning models M1 and M2 as the programs are executed. Then, the process described above is repeated.

When I≤c is not satisfied (NO in S76), the mean value mean and the confidence interval (t0,t1) are output (S77). Thus, the process is ended.

Note that, e.g., δ:=1.96×(σ\hat{ }2/n)\hat{ }(½) and σ:=α×β/{(α+β+1)×(α+β)\hat{ }2} may also be implemented.

According to the present embodiment, it is possible to perform the behavioral equivalence checking even considering the smoothness of the pre-trained models. Accordingly, the next time operator X is introduced into the BLTL formula. In the method in which the BSMC is applied to an analog circuit, the next time operator X cannot be used. However, in the present embodiment, attention is focused on the fact that the use of the next time operator can be limited only to the application of the next time operator to the output values to allow the next time operator to be described. On the other hand, when the maximum number of times the next time operator X included in the BLTL formula is repeated is k, up to k output values are assigned to a propositional logical formula and whether or not the logical formula is satisfied is determined. By doing so, it is possible to determine whether or not the BLTL formula including the next time operator X is satisfied. This allows the behavioral equivalence checking even considering the smoothness of the pre-trained models to be implemented in a realistic period of time.

In the second embodiment, the training device sequentially inputs sequence data as the checking test data and determines the n-th (where n is an integer of not less than 1) and lower order differences in the output sequence data corresponding to the sequence data. Then, the training device determines whether or not the first and second execution results including the n-th and lower order differences satisfy the logical formula shown above in the Bayesian statistical model checking method. This allows the behavioral equivalence checking even considering the smoothness of the pre-trained models to be implemented in a realistic period of time.

In the present second embodiment, in the steps (A) and (B) in the first embodiment, the sequence data is sequentially input as the checking data, and the n-th (n is an integer of not less than 1) and lower order differences in the output sequence data corresponding to the sequence data are determined. In the step (C) in the first embodiment, it is determined whether or not the first and second execution results including one or more of the n-th and lower differences satisfy the logical formula shown above. This allows behavioral equivalence even considering the smoothness of the pre-trained models to be evaluated.

### Third Embodiment

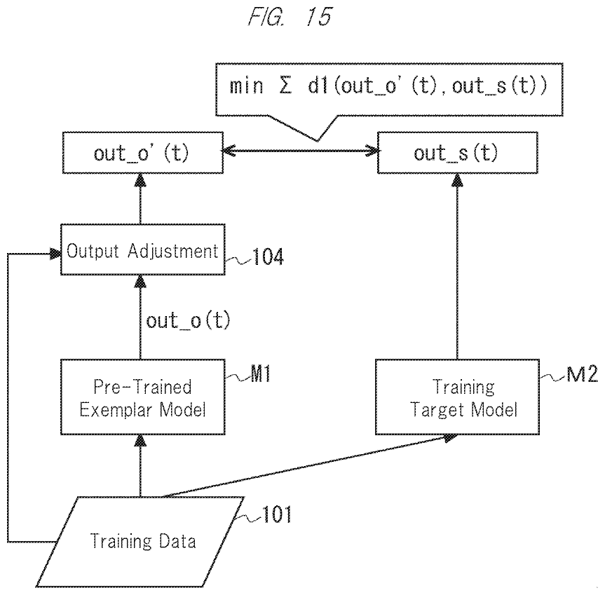

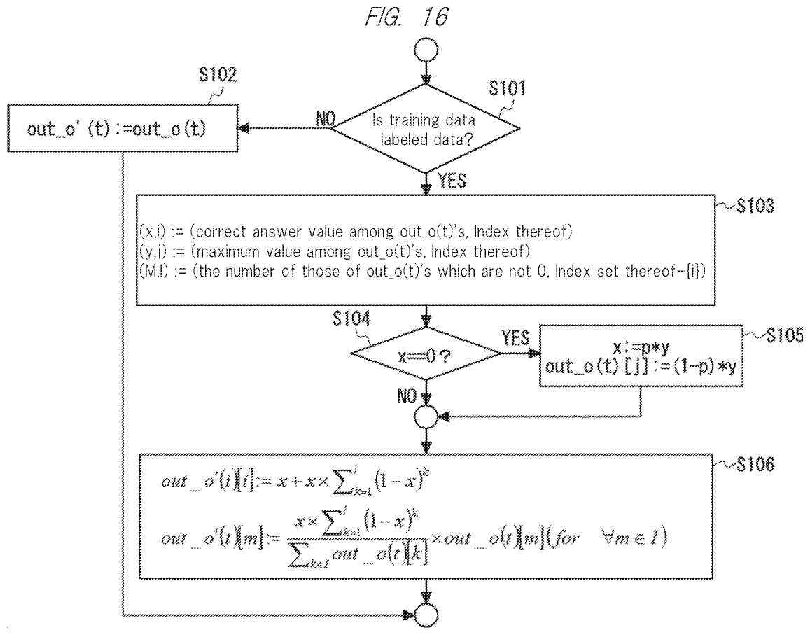

In the present embodiment, a description will be given of a training method which allows the behavior of the learning model serving as an exemplar to be maintained. FIG. 15 is a view showing an example of a training device which allows behavioral equivalence to be maintained as much as possible. The machine learning training performed herein is intended for discrimination and classification. In particular, the machine learning training performed herein is intended for general supervised learning such as k-nearest neighbor, a decision tree (classification tree), a neural network, a Bayesian network, a support vector machine, or (multinominal) logistic regression. The signs seen in FIGS. 15 and 16 are as follows.

[Math. 4]

d1(x,y): A loss function formed of any norm such as L1-norm, L2-norm, Lp-norm, or L∞-norm, KL-Divergence (Kullback-Leibler-Divergence), Jensen-Shannon-Divergence, a k-th power error (where k is a real number satisfying k≠0), or the like
out_o(t):={out_o[1], . . . ,out_o[N]}(t): A t-th output from an exemplar model
out_o′(t):={out_o′[1], . . . ,out_o′[N]}(t): An adjusted t-th output from the exemplar model
out_s(t):={out_s[1], . . . ,out_s[N]}(t): A t-th output from a training target model

The training method according to the present embodiment is a method obtained by extending a teacher-student training method. Specifically, a pre-trained exemplar model (referred to as the first learning model M1) the behavior of which is intended to be maintained is assumed to be a teacher model. On the other hand, a student learning model as the target of training which allows the behavior to be maintained as much as possible is assumed to be a training target model (referred to as the second learning model M2). It is assumed that, as supervised training data, labeled data is given. Training data 101 as labeled data is input to the first learning model M1. Then, the output out_o(t) from first learning model M1 is adjusted (corrected) using a correct answer label. The adjusted output out_o′(t) is used to train the second learning model M2. The training is performed so as to minimize the following expression (1).

[Math. 5]

Σd1(out_o′(t),out_s(t)) (1)

When the second learning model M2 is a neural network, it is assumed that, e.g., d1 is KL (Kullback-Leibler)-divergence, and error back-propagation is performed. As necessary, it may also be possible to introduce a regularization term and then perform error back-propagation. Thus, the student learning model is trained.

In particular, a method associated with optimization of training or re-training of a neural network such as, e.g., a bit width reduction using sparse learning or quantization or Distillation may also be implemented in combination. In addition, re-training may be performed any number of times. When the second learning model M2 is multinominal logic regression, d1 is assumed to be, e.g., a square error, and residual error minimization is performed. As necessary, it may also be possible to introduce a regularization term and then perform residual error minimization. Thus, the second learning model M2 is trained. When the second learning model M2 is another leaning model such as a decision tree, a loss function is calculated using out_o′(t) and out_s(t). Then, on the basis of the loss function, the second learning model M2 may be trained appropriately.

In the present training method, the first training model M1 and the second training model M2 need not necessarily be identical. For example, it may also be possible that the first learning model M1 is a multinominal logistic regression pre-trained model and the second learning model M2 is a gradient boosting decision tree. The present training method also corresponds to supervised learning using newly obtained data instead of the training data used in the construction of the teacher model. Note that, in the construction of the teacher model, semi-supervised learning may also be implemented. This is obvious from FIGS. 15 and 16. Additionally, the input stage of the second learning model M2 may also include a mechanism of extracting attributes such as mean, median, dispersion, discrete cosine transform, and HOG (Histogram of Oriented Gradients).

FIG. 16 shows an example of the output adjustment algorithm shown in FIG. 15. The signs seen in FIG. 16 are as follows.

t: The order of data items

l: An input parameter, which is an integer of not less than

p: An input parameter, which is a real number larger than 0.5 and smaller than 1.0

It is assumed that, in the present algorithm, out_o(t)'s and out_s(t)'s are normalized such that each of the total sum of out_o(t)'s and the total sum of out_s(t)'s is 1. It is also assumed that, when out_o(t)'s and out_s(t)'s are not normalized, out_o(t)'s and out_s(t)'s are normalized, adjusted, and then summed to produce outputs.

In FIG. 16, the following process is performed on each t-th output data. First, it is checked whether or not the training data 101 is labeled data (S101). Specifically, it is checked whether or not the training data 101 has a teacher label. When the training data 101 is not labeled data, out_o′(t):=out_o(t) is implemented (S102). When there is next output data, the process moves to S101. When there is no next output data, the process is ended.

When the training data 101 is labeled data, the process moves to S103. When a teacher pre-trained model is constructed by supervised learning, a teacher label is given to each of the training data items 101 so that YES is constantly given as the result of the determination in S101.

In S103, the following process is performed:

(x,i):=(correct answer value among out_o(t)'s, Index thereof)

(y,j):=(maximum value among out_o(t)'s, Index thereof)

(M,I):=(the number of those of out_o(t)'s which are not 0, Index set thereof−{i})

Next, it is determined whether or not x==0 is satisfied (S104). When x==0 is not satisfied (NO in S104), the process moves to S106. When x==0 is satisfied (YES in S104), x:=p*y,out_o(t)[j]:=(1−p)*y is implemented (S105).

Then, the following expression (2) is implemented (S106).

$$\begin{matrix} [ Math . 6 ] & \\ {out\_o}^{′} ( i ) [ i ] := x + x \times {\sum }_{k = i}^{l} {( 1 - x )}^{k} , \\ {out\_o}^{′} ( t ) [ m ] := \frac{x \times {\sum }_{k = 1}^{l} {( 1 - x )}^{k}}{{\sum }_{k ∈ l} out\_ o ( t ) [ k ]} \times out\_o ( t ) [ m ] ( for ∀ m ∈ I ) & ( 2 )\end{matrix}$$

When there is next output data, the process moves to S101. When there is no next output data, the process is ended. It is to be noted herein that, as I is increased, a correct answer value is emphasized by the following expression (3). The training method described above allows training which allows the behavior of the exemplar model to be maintained to be performed.

[Math. 7]

x+x×Σₖ₌₁^{l}(1−x)^{k}→1(as l→∞) (3)

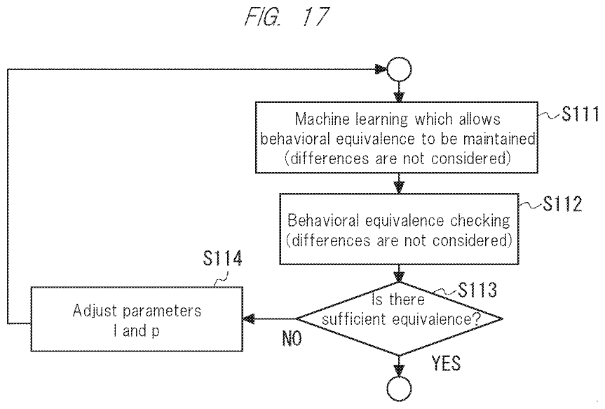

FIG. 17 shows a training method which is a combination of the training method in FIG. 15 and the evaluation method for behavioral equivalence shown in the first embodiment.

Note that the signs 1 and p seen in FIG. 17 are as follows.

l: An input parameter to the output adjustment algorithm in FIG. 15, which is an integer of not less than 1

p: An input parameter to the output adjustment algorithm in FIG. 15, which is a real number larger than 0.5 and smaller than 1.0

The example shown herein uses the behavioral equivalence checking method formed of the first example of the first embodiment. However, it may also be possible to use the behavioral equivalence checking method formed of the second example of the first embodiment. In other words, the equivalence checking is performed herein on the basis of the Bayes factor B, but it may also be possible to perform the equivalence checking on the basis of the Bayesian posterior probability I. Additionally, it is assumed that the input parameters l and p required for machine learning which allows behavioral equivalence to be maintained are given as appropriate.

Machine learning illustrated in FIGS. 15 and 16 which allows behavioral equivalence to be maintained is performed to train the learning models M1 and M2 (S111). Next, on the learning models M1 and M2, behavioral equivalence checking including FIGS. 5 and 7 is performed (S112).

On the basis of the result of the behavioral equivalence checking, it is determined whether or not the first learning model M1 and the second learning model M2 have sufficient equivalence therebetween (S113). Specifically, it is determined whether or not the behaviors thereof match with a probability of not less than the required probability Θ.

When the first learning model M1 and the second learning model M2 have sufficient equivalence therebetween (YES in S113), the process is ended. When the first learning model M1 and the second learning model M2 do not have sufficient equivalence therebetween (NO in S113), the parameters l and p are adjusted (S114). Then, using the adjusted parameters l and p, the process starting in S111 is performed.

In the adjustment of the parameters, e.g., 1=1 is established and p is increased from 0.6 in 0.1 increments. As a result, when YES is not given in S113, l is incremented in 1 increments. l is incremented and p is similarly increased from 0.6 in 0.1 increments. It may also be possible to repeat the updating of the parameters l and p until YES is given in S113.

It is possible to implement training of the target model which maintains the behavior of an exemplar model as much as possible. It is possible to simplify the learning model or replace the learning model with a simpler learning model, while allowing the behavior of the exemplar model to be maintained as much as possible. It is possible to train the second learning model as the target such that the second learning model maintains behavioral equivalence to the first learning model as the exemplar model. This allows for, e.g., replacement of the exemplar model to the target model having a footprint smaller than that of the exemplar model.

The training device according to the present embodiment may also perform the following steps (1) to (4).

(1) obtaining, using the training data, the first output result based on the first learning model as the teacher model;

(2) obtaining, using the foregoing training data, the second output result based on the second learning model as the student model;

(3) determining the evaluation parameters l and p on the basis of the foregoing first output result and the foregoing second output result and implementing machine learning training of the second learning model; and

(4) comparing the respective behaviors of the foregoing first learning model and the foregoing pre-trained second learning model with each other.

To the step (4), the evaluation methods in the first and second embodiments may also be applied. Specifically, the step (4) may also include steps (4-1) to (4-4) of:

(4-1) obtaining, using checking data, a first execution result based on the first learning model;

(4-2) obtaining, using the checking data, a second execution result based on the second learning model;

(4-3) determining whether or not the first and second execution results satisfy a logical formula; and

(4-4) evaluating, using a Bayesian statistical model checking method, behavioral equivalence between the first learning model and the second learning model on the basis of a result of the determination in the step (4-3).

### Fourth Embodiment

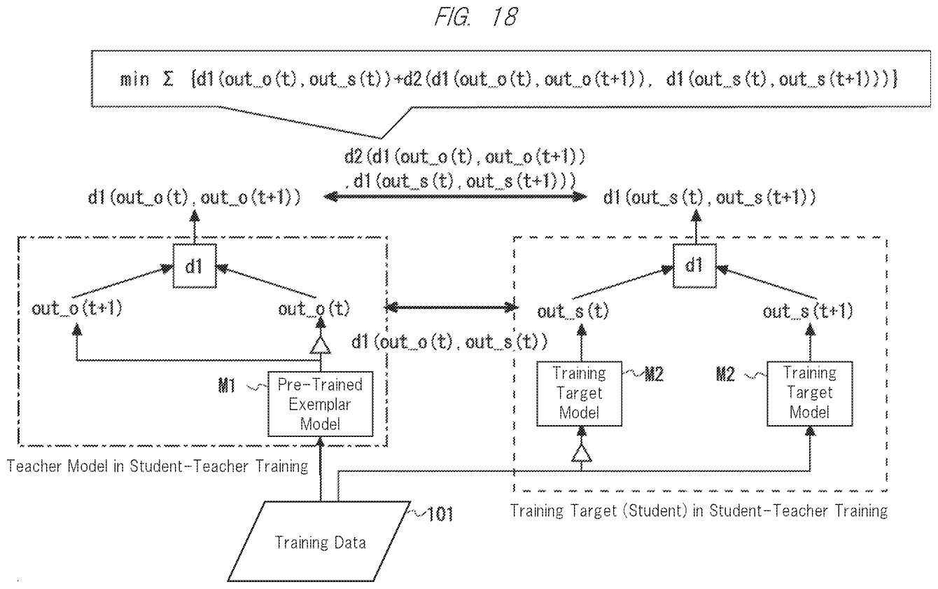

A fourth embodiment will describe a training method which allows equivalence considering the smoothness of behaviors to be maintained as much as possible. FIG. 18 is a view for illustrating a machine learning training method according to the fourth embodiment.

The machine learning training in FIG. 18 is intended for discrimination and classification. In the fourth embodiment, e.g., the machine learning training is intended for general supervised learning such as k-nearest neighbor, a decision tree (classification tree), a neural network, a Bayesian network, a support vector machine, (multiple linear) regression, or (multinominal) logistic regression. The signs seen in the drawing are as follows.

### [Math. 8]

t: The order of data items
d1(x,y), . . . , dn(x,y): A loss function formed of any norm such as L1-norm, L2-norm, Lp-norm, or L∞-norm, KL-Divergence (Kullback-Leibler-Divergence), Jensen-Shannon-Divergence, a k-th power error (where k is a real number satisfying k≠0), or the like, where d1, . . . ,dn may be either the same or different out_o(t):={out_o[1], . . . ,out_o[N]}(t): A t-th output from the exemplar model out_st(t):={out_s[1], . . . ,out_s[N]}(t): A t-th output from the training target model

FIG. 18 shows a method obtained by extending a teacher-student training method such that differences in output sequences are considered. The main differences between FIGS. 18 and 15 are as follows. In FIG. 18, outputs from the first learning model M1 and the first order difference therebetween are used as labeled teacher data. Also, to allow for training considering the first order difference between the outputs, two student learning models (second learning models M2) are arranged, and the portion which calculates the first order difference between the outputs is assumed to be included in the student learning models. In addition, FIG. 18 is different from FIG. 15 in that output adjustment is not performed on the teacher pre-trained model. The training even considering the first order difference is performed so as to minimize Expression (4) shown below.

[Math. 9]

Σ{d1(out_o(t),out_s(t))+d2(d1(out_o(t),out_o(t+1),d1(out_s(t),out_s(t+1)))} (4)

When each of the student learning models (second learning models M2) is a neural network, it is assumed that, e.g., d1 is a square error and d2 is KL-Divergence, and error back-propagation is performed. As necessary, it may also be possible to introduce a regularization term and then perform error back-propagation. Thus, the student learning model is trained. In particular, it may also be possible for a processor to implement a method associated with optimization of training or re-training of a neural network such as, e.g., a bit width reduction using sparse learning or quantization or Distillation in combination. In addition, re-training may be performed any number of times.

When the student learning model is multinominal logic regression or multiple linear regression, d1 and d2 are assumed to be, e.g., square errors, and residual error minimization is performed. As necessary, it may also be possible to introduce a regularization term and then perform residual error minimization. Thus, the student learning model is trained. When the student learning model is another learning model such as a decision tree, a loss function is calculated. A processor may appropriately train the student learning model on the basis of the loss function. The loss function can be calculated using out_o(t), out_s(t), d1(out_o(t),out_o(t+1)), and d1(out_s(t),out_s(t+1)).

In the present training, the teacher model and the student learning model need not necessarily be identical. For example, it may also be possible that the teacher model is a multinominal logistic regression pre-trained model and the student learning model is a gradient boosting decision tree. The training method according to the present embodiment also corresponds to supervised learning using newly obtained data instead of the training data used in the construction of the pre-trained teacher model. Note that, in the construction of the teacher model, semi-supervised learning may also be implemented. Additionally, the first input stage of the student learning model may also include a mechanism of extracting attributes such as mean, median, dispersion, discrete cosine transform, and HOG.

### First Modification of Fourth Embodiment

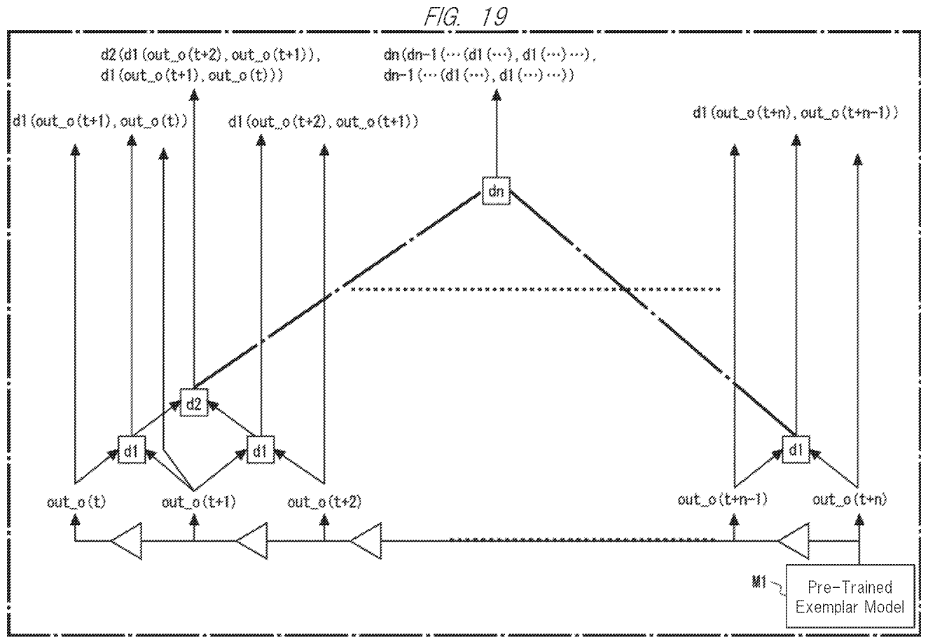

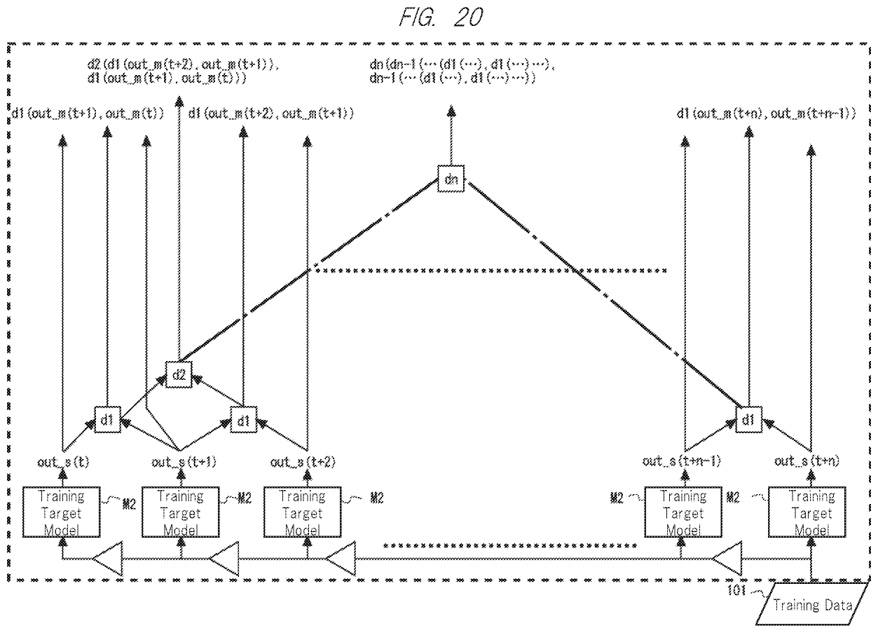

FIG. 18 shows the example of the training device which allows behavior considering the first and lower order differences to be maintained as much as possible. However, it is easy to extend the example to training which allows behavior considering n-th and lower order differences to be maintained as much as possible. FIG. 19 shows a teacher pre-trained model considering the n-th and lower order differences. FIG. 20 shows a student learning model considering the n-th and lower order differences.

The models shown in FIGS. 19 and 20 are applied to the corresponding portions in FIG. 18. Specifically, to the teacher model (dot-dash line) shown by the dot-dash line frame in FIG. 18, the teacher pre-trained model in FIG. 19 is applied. Also, to the student model shown by the dotted line frame in FIG. 18, the student learning model in FIG. 20 is applied. For each of the n-th and lower order difference outputs, an appropriate function such as a distance function or an error function is selected. Then, it is appropriate to produce outputs from the selected function and perform training so as to minimize the total sum of the produced outputs in the order t of data items. It is assumed herein that the calculation of the differences is performed by selecting an appropriate distance function or error function. The 0-th order difference corresponds to direct outputs from the learning models M1 and M2. It is assumed that n is an integer of not less than 0.

From the configurations in FIGS. 19 and 20, it can be seen that training which allows some of the n-th and lower order differences to be maintained as much as possible instead of using all the n-th and lower order differences can also be easily implemented. This is because, actually, it is sufficient to merely form a loss function using the selected differences. For example, it is assumed that m is an integer of not less than 0 and smaller than n. From FIGS. 19 and 20, it is obvious that the learning model considering the n-th and lower order differences internally includes models considering m-th and lower order differences. It is sufficient that the loss function is formed using one or more of the n-th and lower order differences. Training is performed so as to minimize the loss function.

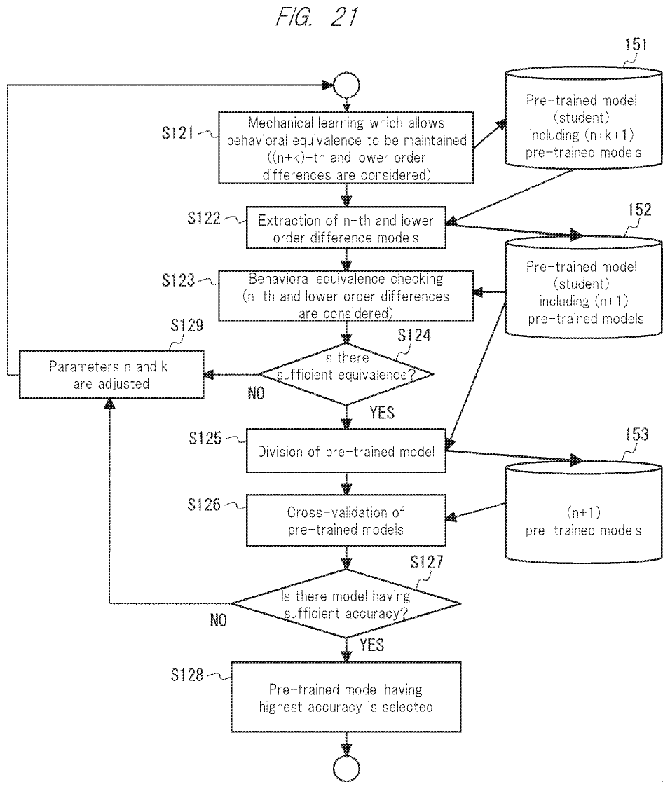

FIG. 21 shows a training method which is a combination of the training method shown in FIGS. 18 to 20 and the equivalence checking method in the first or second embodiment. The basic concept of the present training method is as follows. By implementing training considering (n+k)-th and lower order differences, training which allows smoother behavioral equivalence to be maintained as much as possible is implemented. Also, as the equivalence checking, behavioral equivalence checking considering the n-th and lower order differences, which is a less strict condition, is used appropriately. Then, among the student pre-trained models that have succeeded in the checking, a most accurate, i.e., likeliest student pre-trained model is constructed by cross-validation.

The signs seen in FIG. 21 are as follows.

n: An input parameter representing a difference to be considered, which is an integer of not less than 0

k: An input parameter representing the offset of the difference to be considered, which is an integer of not less than 0

An example adopting the behavioral equivalence checking method according to the first example of the second embodiment is shown herein. Needless to say, the behavioral equivalence checking method according to the second example of the second embodiment may also be adopted. It is assumed that the input parameters required by the behavioral equivalence checking are given as appropriate. Note that, when n=0 is satisfied, the behavioral equivalence checking according to the first example of the first embodiment is used. Needless to say, when n=0 is satisfied, the behavioral equivalence checking method according to the second example of the first embodiment may also be adopted.

First, as shown in FIGS. 18 to 20, machine learning training considering the (n+k)-th and lower order differences which allows behavioral equivalence to be maintained is implemented (S121). As a result, a student pre-trained model 151 is constructed. The student pre-trained model 151 internally includes (n+k+1) student learning models considering no difference.

From among the (n+k+1) student pre-trained models 151, n-th and lower order difference models are extracted (S122). In other words, partial models of (n+1) pre-trained models 152 having outputs from out_s(t+n+k) to out_s(t+k) are acquired.

Behavioral equivalence checking considering the n-th and lower order differences is performed (S123). The behavioral equivalence checking shown in FIGS. 9 and 13 is performed herein. When n=0 is satisfied, the behavioral equivalence checking shown in FIGS. 5 and 7 is performed.

On the basis of the result of the behavioral equivalence checking, it is determined whether or not the models have sufficient behavioral equivalence therebetween (S124). In other words, it is determined whether or not the behaviors thereof match with a probability of not less than the required probability Θ. When the probability that the behaviors thereof match is not less than Θ, it is determined that the models have sufficient behavioral equivalence therebetween. When the probability that the behaviors thereof match is less than Θ, it is determined that the models do not have sufficient behavioral equivalence therebetween.

When it is determined that the models do not have sufficient behavioral equivalence therebetween (NO in S124), the process moves to S129 to adjust the parameters n and k. The process in S129 will be described later. When it is determined that the models have sufficient behavioral equivalence therebetween (YES in S124), the pre-trained model is divided (S125). As a result, (n+1) pre-trained models 153 are stored.

Then, cross-validation is performed on the (n+1) pre-trained models (S126). It is determined whether or not the (n+1) pre-trained models include a model having sufficient accuracy (S127). When it is determined that there is no model having sufficient accuracy (NO in S127), the process moves to S129. When it is determined that there is a model having sufficient accuracy (YES in S127), the pre-trained model having the highest accuracy is selected (S128). In other words, the model having the highest probability of satisfying the logical formula ϕ is selected as the likeliest pre-trained model. Accordingly, it is possible to construct the learning model which allows for maintenance of the behavioral equivalence to the exemplar model.

In S129, the parameters n and k are adjusted, and then the process returns to S121. Specifically, for example, the parameter adjustment in S129 is performed as follows. After n=0 is established, k is increased from 1 to 5 in 1 increments. When YES is not given as the result of the determination in S127 before k becomes 5, n is incremented. Specifically, n is increased by 1, while k is similarly increased from 1 to 3 in 1 increments. It may also be possible to repeat such updating of n and k until n=5 is satisfied. It may also be possible that, when sufficient behavioral equivalence is not obtained as a result of the repeating, the process is ended. It is assumed herein that n and k are static variables. Needless to say, n and k are not limited to the values shown above.

### Second Modification of Fourth Embodiment

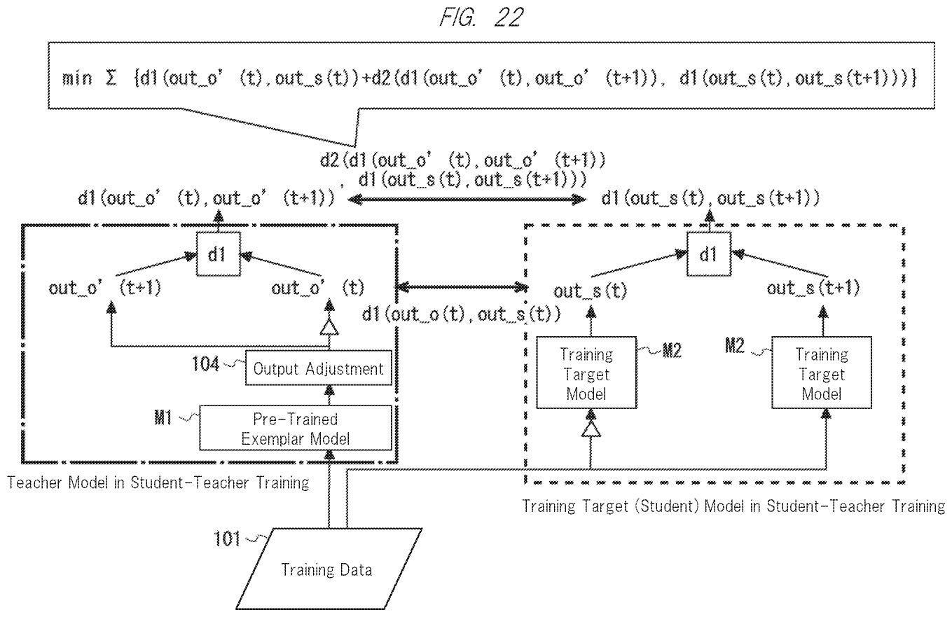

A description will be given of a training device and a training method according to a second modification of the fourth embodiment using FIG. 22. In the second modification, the machine learning training is intended for discrimination and classification. The machine learning training is intended for general supervised learning such as k-nearest neighbor, a decision tree (classification tree), a neural network, a Bayesian network, a support vector machine, (multiple linear) regression, or (multinominal) logistic regression. The signs seen in FIG. 22 are as follows.

### [Math. 10]

t: The order of data items
d1(x,y), . . . , dn(x,y): A loss function formed of any norm such as L1-norm, L2-norm, Lp-norm, or L∞-norm, KL-Divergence (Kullback-Leibler-Divergence), Jensen-Shannon-Divergence, a k-th power error (where k is a real number satisfying k≠0), or the like
out_o(t):={out_o[1], . . . ,out_o[N]}(t): A t-th output from the exemplar model
out_o′(t):={out_o′[1], . . . ,out_o′[N]}(t): A t-th adjusted output from the exemplar model
out_st(t):={out_s[1], . . . ,out_s[N]}(t): A t-th output from the training target model

The method in FIG. 22 is obtained by extending the student-teacher training method, while considering the n-th and lower order differences. In FIG. 18, the output adjustment in FIG. 15, FIG. 16, or the like is performed on a teacher pre-trained model. The training considering the first and lower order differences is performed so as to minimize the following formula (5).

[Math. 11]

{d1(out_o′(t),out_s(t))+d2(d1(out_o′(t),out_o′(t+1),d1(out_s(t),out_s(t+1)))} (5)

When the student learning model is a neural network, it is assumed that, e.g., d1 is a square error and d2 is KL-Divergence, and error back-propagation is performed. Thus, the student learning model is trained. As necessary, it may also be possible to introduce a regularization term and then perform error back-propagation.

In particular, a method associated with optimization of training or re-training of a neural network such as, e.g., a bit width reduction using sparse learning or quantization or Distillation may also be performed in combination. In addition, re-training may be performed any number of times. When the student learning model is multinominal logic regression or multiple linear regression, d1 and d2 are assumed to be, e.g., square errors, and residual error minimization is performed. As necessary, it may also be possible to introduce a regularization term and then perform residual error minimization. Thus, the student learning model is trained.

When the student learning model is another learning model such as a decision tree, a loss function is calculated using out_o′(t), out_s(t), d1(out_o′(t),out_o′(t+1)), and d1(out_s(t),out_s(t+1)). Then, on the basis of the loss function, the student learning model may be trained as appropriate.

Note that, in the present training method, the pre-trained teacher model and the student learning model need not necessarily be identical. For example, it may also be possible that the teacher is a multinominal logistic regression pre-trained model and the student is a gradient boosting decision tree. The present training method also corresponds to supervised learning using newly obtained data instead of the training data used in the construction of the pre-trained teacher model. In the construction of the teacher model, semi-supervised learning may also be implemented. Additionally, the first input stage of the student learning model may also include a mechanism of extracting attributes such as mean, median, dispersion, discrete cosine transform, and HOG.

FIG. 22 shows the example of the training which allows behavior considering the first and lower order differences to be maintained as much as possible. However, it is easy to extend the example to training which allows behavior considering n-th and lower order differences to be maintained as much as possible. It may be appropriate to apply the models in FIGS. 19 and 20 to the corresponding portions in FIG. 22. More specifically, to the teacher model, output adjustment 104 performed on the outputs from the pre-trained model in FIG. 18 may be added to FIG. 19 to be applied as appropriate. To the target model, the configuration of the student learning model considering the n-th and lower order differences shown in FIG. 20 may be applied as appropriate.

For each of the n-th and lower order difference outputs, an appropriate function such as a distance function or an error function is selected. Then, it is appropriate to produce outputs from the selected function and perform training so as to minimize the total sum of the produced outputs in the order t of data items. It is assumed herein that the calculation of the differences is performed by selecting an appropriate distance function or error function. The 0-th order difference corresponds to direct outputs from the learning models M1 and M2. It is assumed that n is an integer of not less than 0.

From the configurations in FIGS. 19 and 20, it can be seen that training which allows some of the n-th and lower order differences to be maintained as much as possible instead of using all the n-th and lower order differences can also be easily implemented. This is because, actually, it is sufficient to merely form a loss function using the selected differences.

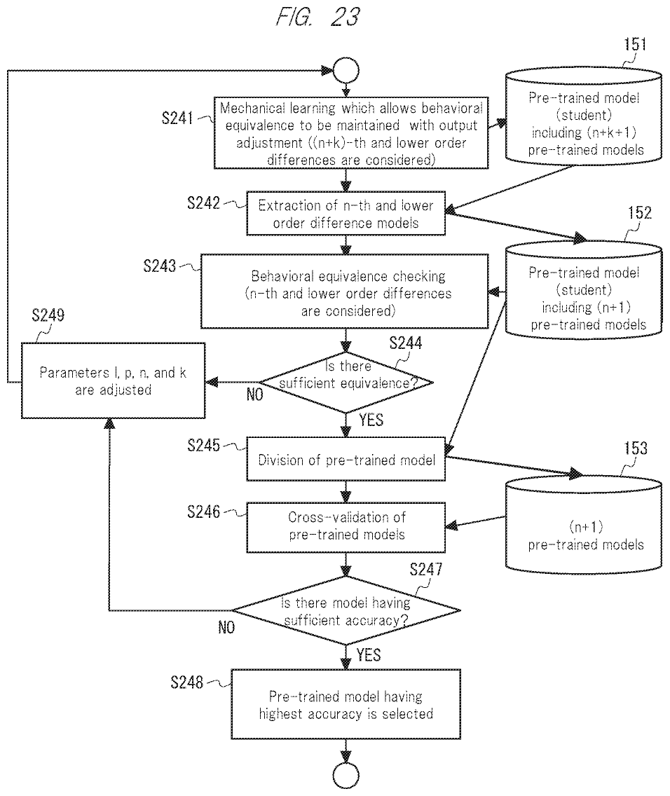

Using FIG. 23, a description will be given of the training method according to the second modification. FIG. 23 is a flow chart showing a process considering the n-th and lower order differences for the training device in FIG. 22. In FIG. 23, the output adjustment 104 is performed on the outputs from the exemplar model shown in FIG. 19. In addition, the training target model (second learning model M2) in FIG. 20 is used appropriately.

The basic concept of the present method is as follows. By implementing training considering (n+k)-th and lower order differences using the labeled teacher data involving the output adjustment, training which allows smoother behavioral equivalence to be maintained as much as possible can be implemented. Also, as the equivalence checking, behavioral equivalence checking considering the n-th and lower order differences, which is a less strict condition, is used appropriately. Then, among the pre-trained student models that have succeeded in the checking, a most accurate, i.e., likeliest pre-trained student model is constructed by cross-validation.

The signs seen in FIG. 23 are as follows.

n: An input parameter representing a difference to be considered, which is an integer of not less than 0

k: An input parameter representing the offset of the difference to be considered, which is an integer of not less than 0

l: An input parameter to the output adjustment algorithm, which is an integer of not less than 1

p: An input parameter to the output adjustment algorithm, which is a real number larger than 0.5 and smaller than 1.0

For the sake of ease, an example adopting the behavioral equivalence checking method according to the first example of the second embodiment is shown herein. However, the behavioral equivalence checking method according to the second example of the second embodiment may also be adopted. It is assumed that the input parameters required by the behavioral equivalence checking are given as appropriate. Note that, when n=0 is satisfied, the behavioral equivalence checking according to the first example of the first embodiment is used. Needless to say, when n=0 is satisfied, the behavioral equivalence checking method according to the second example of the first embodiment may also be adopted.

Machine learning training considering the (n+k)-th and lower order differences which allows behavioral equivalence to be maintained is implemented (S141). The training is performed herein after the output adjustment 104 is applied to FIG. 19. The training is also performed after FIG. 20 is applied to FIG. 22. As a result, the student pre-trained model 151 is constructed. The student pre-trained model 151 internally includes (n+k+1) pre-trained student models considering no difference.

Among the (n+k+1) student pre-trained models 151, n-th and lower order difference models are extracted (S142). In other words, partial models of the (n+1) pre-trained models 152 having outputs from out_s(t+n+k) to out_s(t+k) are acquired.

Behavioral equivalence checking considering the n-th and lower order differences is performed (S143). The behavioral equivalence checking shown in FIGS. 9 and 13 is performed herein. When n=0 is satisfied, the behavioral equivalence checking shown in FIGS. 5 and 7 is performed.

On the basis of the result of the behavioral equivalence checking, it is determined whether or not the models have sufficient behavioral equivalence therebetween (S144). In other words, it is determined whether or not the behaviors thereof match with a probability of not less than the required probability Θ. When the probability that the behaviors thereof match is not less than Θ, it is determined that the models have sufficient behavioral equivalence therebetween. When the probability that the behaviors thereof match is less than Θ, it is determined that the models do not have sufficient behavioral equivalence therebetween.

When it is determined that the models do not have sufficient behavioral equivalence therebetween (NO in S144), the process moves to S149. When it is determined that the models have sufficient behavioral equivalence therebetween (YES in S144), the pre-trained model is divided (S145). As a result, the (n+1) pre-trained models 153 are stored.

Then, cross-validation is performed on the (n+1) pre-trained models (S146). It is determined whether or not the (n+1) pre-trained models include a model having sufficient accuracy (S147). When it is determined that there is no model having sufficient accuracy (NO in S147), the process moves to S149. When it is determined that there is a model having sufficient accuracy (YES in S147), the pre-trained model having the highest accuracy is selected (S148). In other words, the model having the highest probability of satisfying the logical formula ϕ is selected as the likeliest pre-trained model. Accordingly, it is possible to construct the learning model which allows for maintenance of the behavioral equivalence to the exemplar model.

In S149, the parameters l, p, n, and k are adjusted, and then the process returns to S141. For example, the parameter adjustment in S149 is performed as follows. While n=0 is established and k is increased from 1 to 5 in 1 increments, l=1 is established and p is increased from 0.6 in 0.1 increments. As a result, when YES is not given as the result of the determination in S147, l is incremented and p is similarly increased from 0.6 in 0.1 increments. Such updating of the parameters l and p is repeated until l=5 is satisfied or YES is given in S147.

When YES is not given as the result of the determination in S147, n is incremented and k is similarly increased from 1 to 3 in 1 increments, while l=1 is established and p is increased from 0.6 in 0.1 increments. When YES is not given as the result of the determination in S147, l is incremented and p is similarly increased from 0.6 in 0.1 increments. Such updating of l and p is repeated until l=5 is satisfied or YES is given as the result of the determination in S147. It may also be possible to repeat such updating of l, p, n, and k until n=5 is satisfied. It may also be possible that, when sufficient behavioral equivalence is not obtained in S144 as a result of the repeating, the process is ended.

It is assumed herein that l, p, n, and k are static variables. Needless to say, l, p, n, and k are not limited to the values shown above.

Thus, in the fourth embodiment, the first and higher order differences are considered. By doing so, it is possible to evaluate behavioral equivalence even considering smoothness. Accordingly, it is possible to construct a learning model having the behavior including smoothness which is equivalent to that of the exemplar model.

### Fifth Embodiment

### First Example of Fifth Embodiment

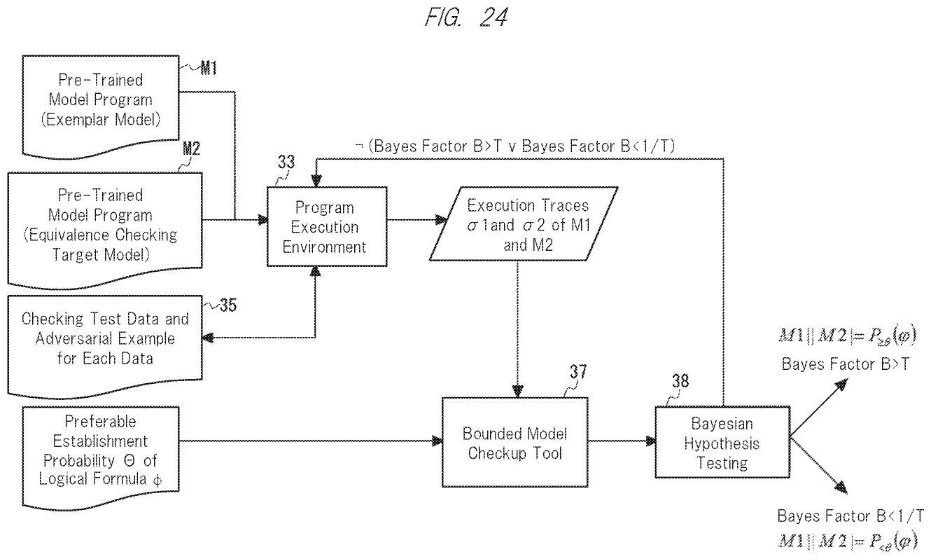

A fifth embodiment discloses a training method for acquiring resistance to an Adversarial Example. FIG. 24 shows a training device which checks equivalence between a pre-trained model (first learning model M1) which does not have the adversarial example resistance and a pre-trained model (second learning model M2) as a checking target. In the fifth embodiment, in the same manner as in the first to fourth embodiments, the BSMC method is used. Then, it is determined whether or not the second learning model M2 has successfully acquired an adversarial example property.

In the present embodiment, checking test data and an adversarial example for each checking test data item are used as the test data 35. To the checking test data and the individual data items included therein, data items forming the adversarial example are added to re-construct the test data 35.

The test data 35 is input to the program execution environment 33. Using the input data, the program execution environment 33 executes the first learning model M1 and the second learning model M2. Thus, the execution traces σ1 and σ2 are acquired.

In addition, a property to be satisfied by the first and second learning models M1 and M2 with respect to equivalence is defined in advance by the logical formula ϕ. The logical formula ϕ is described in, e.g., a bounded linear temporal logic (BLTL) formula. The preferable establishment probability of the logical formula ϕ is defined in advance as a determination value Θ. For the logical formula ϕ, the fifth and sixth examples shown in the first embodiment can be used. Needless to say, another logical formula may also be used.

The bounded model checker tool 37 checks whether or not the execution traces σ1 and σ2 satisfy the logical formula ϕ using the BMC. In other words, the bounded model checker tool 37 checks whether or not σ1∥σ2|=ϕ is established using the BMC. The bounded model checker tool 37 calculates the Bayes factor B on the basis of the result of checking using the BMC.

The bounded model checker tool 37 determines whether or not the Bayesian hypothetical testing 38 is worth performing on the basis of the Bayes factor B. The Bayesian hypothetical testing 38 is a test for determining whether or not the establishment probability of σ1∥σ2|=ϕ is not less than the determination value Θ. As shown in the second embodiment, the program execution environment 33 forms input data by performing random sampling with replacement on the test data 35. Accordingly, the program execution environment 33 can acquire the execution traces σ1 and σ2 until the Bayesian hypothetical testing 38 becomes worth performing. Then, using the BMC, the bounded model checker tool 37 checks whether or not σ1∥σ2|=ϕ is established on the basis of the execution traces σ1 and σ2.

When the Bayes factor B is sufficient to perform the Bayes' hypothetical testing 38, the bounded model checker tool 37 performs the Bayesian hypothetical testing 38 to determine whether or not the establishment probability of σ1∥σ2|=ϕ is not less than the determination value Θ. The bounded model checker tool 37 determines whether or not the probability that the first and second learning models M1 and M2 satisfy the logical formula ϕ is not less than Θ.

Note that M1∥M2|=P_{≥Θ}(ϕ) means that the probability that the first and second learning models M1 and M2 satisfy the logical formula ϕ is not less than Θ. On the other hand, M1∥M2|=P_{≤Θ}(ϕ) means that the probability that the first and second learning models M1 and M2 satisfy the logical formula ϕ is less than Θ.

In the construction of the Adversarial Example, the following paper may also be used.

Synthesizing Robust Adversarial Examples

https://arxiv.org/abs/1707.07397

In using the document shown above, it may also be possible to form an adversarial example which does not always output a complete error by interrupting a Stochastic Gradient Decent operation performed in forming an adversarial example. Needless to say, an adversarial example may also be constructed using another method.

### Second Example of Fifth Embodiment

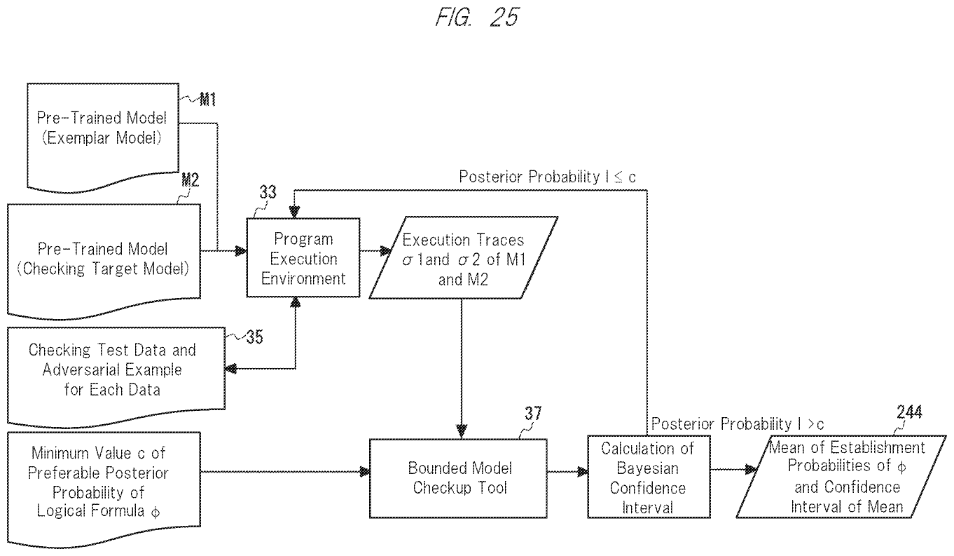

FIG. 25 is a view for illustrating an evaluation device according to a second example of the fifth embodiment. FIG. 25 shows, similarly to FIG. 24, a training device which checks equivalence between the pre-trained model (first learning model M1) which does not have the adversarial example resistance and the pre-trained model (second learning model M2) as the checking target. In the fifth embodiment, in the same manner as in the first to fourth embodiments, the BSMC method is used. Then, it is determined whether or not the second learning model M2 has successfully acquired the adversarial example property.

In the second example also, in the same manner as in the first example, checking test data and an adversarial example for each checking test data item are used as the test data 35. To the checking test data and the individual data items included therein, data items forming the adversarial example are added to re-construct the test data 35.

The test data 35 is input to the program execution environment 33. Using the test data 35, the program execution environment 33 executes the programs as the first learning model M1 and the second learning model M2. Specifically, the program execution environment 33 uses the test data 35 as the input data to execute the first and second learning models M1 and M2 as the programs. Thus, the execution traces σ1 and σ2 of the first and second learning models M1 and M2 can be acquired.

In addition, a property to be satisfied by the first and second learning models M1 and M2 with respect to equivalence is defined in advance by the logical formula ϕ. The logical formula ϕ is described in, e.g., a bounded linear temporal logic (BLTL) formula. For the logical formula ϕ, the fifth and sixth examples shown in the first embodiment can be used. Needless to say, another logical formula may also be used. The minimum value of the preferable posterior probability of the establishment of the logical formula ϕ is defined as the determination value Θ. The determination value c is a constant set in advance.

The bounded model checker tool 37 checks whether or not the execution traces σ1 and σ2 satisfy the logical formula ϕ using the BMC. In other words, the bounded model checker tool 37 checks whether or not σ1∥σ2|=ϕ is established using the BMC. Then, the bounded model checker tool 37 calculates the confidence interval including the mean of the probabilities that σ1∥σ2|=σ is established on the basis of the result of the checking using the BMC.

The bounded model checker tool 37 calculates the Bayesian posterior probability I from the confidence interval. The bounded model checker tool 37 determines whether or not the Bayesian posterior probability I is not less than the determination value c. The program execution environment 33 acquires the execution traces σ1 and σ2 until the Bayesian posterior probability I becomes not less than the determination value c. Specifically, when the Bayesian posterior probability I is less than the determination value c, the program execution environment 33 acquires the execution traces σ1 and σ2 using the next test data 35.

The bounded model checker tool 37 checks whether or not σ1∥σ2|=ϕ is established using the BMC. The bounded model checker tool 37 calculates the mean value of the establishment probabilities and the confidence interval on the basis of the result of the checking.

When the Bayesian posterior probability I is not less than the determination value c, the bounded model checker tool 37 outputs the mean value of the establishment probabilities and the confidence interval. As shown in the second embodiment, the bounded model checker tool 37 forms th input data by performing random sampling with replacement on the cross-validation test data 35 until the Bayesian posterior probability I is not less than the determination value c. Then, by using the test data 35 as the input data, the program execution environment 33 acquires the execution traces σ1 and σ2

Thus, the mean value of the establishment probabilities that the first learning model M1 and the second learning model M2 satisfy the logical formula ϕ and the confidence interval thereof are obtained. Whether or not the preferable establishment probability of σ1∥σ2|=ϕ is satisfied is separately determined herein using the obtained mean value and the obtained confidence interval.

For the construction of the adversarial example, the document shown in the first example can be used. Needless to say, the adversarial example may also be constructed using another method.

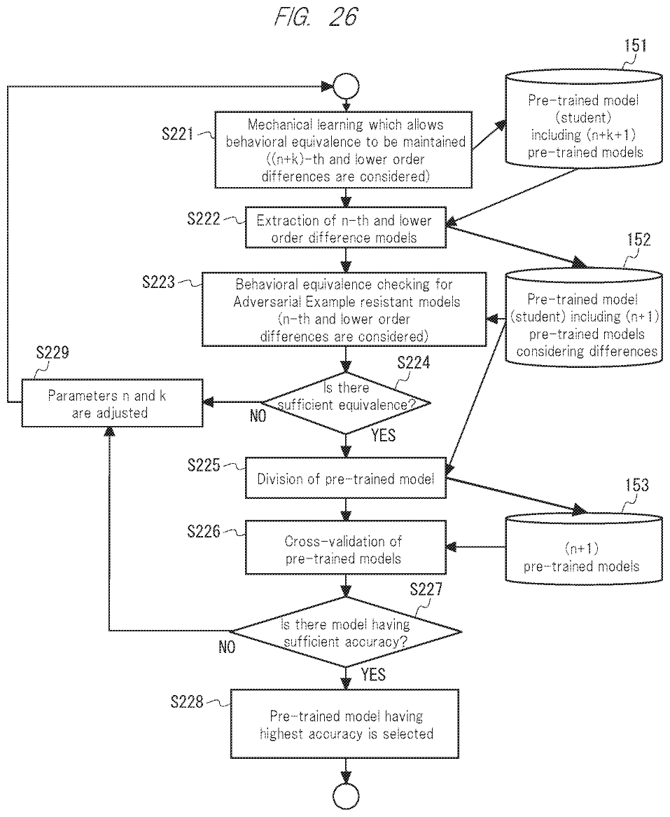

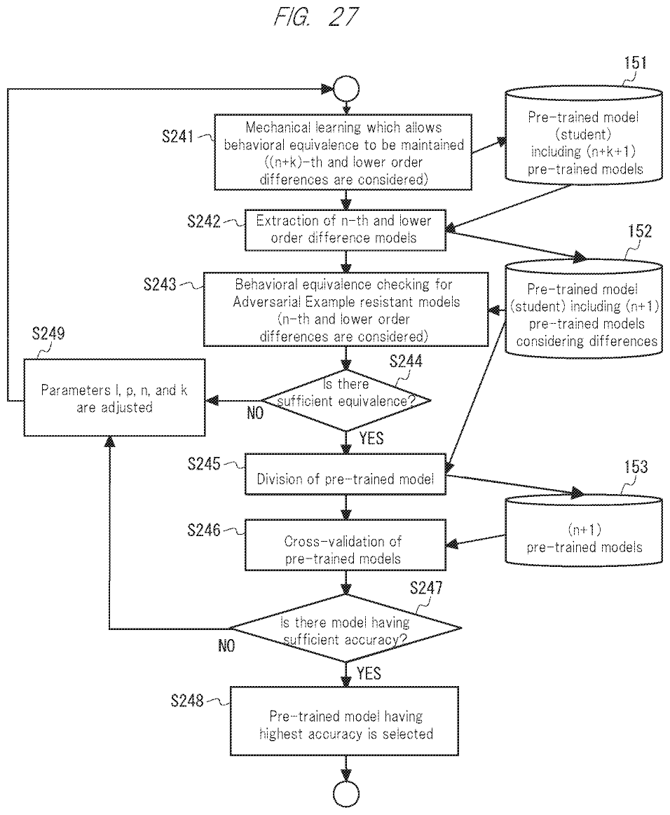

The constructed adversarial example serves as supervised data having a correct answer label given thereto in the present training. Accordingly, by assuming that, when there is no supervised data for the first model M1, outputs from the first learning model M1 other than an output to the adversarial example are used as supervised data for the second learning model M2, the first learning model M1 can be constructed using various methods. For example, it may be possible to assume that the first learning model M1 is a pre-trained model constructed by unsupervised learning, supervised learning, semi-supervised learning, reinforcement learning, or a combination thereof. In particular, when there is no supervised data for the first learning model M1, in FIGS. 26 and 27 described below, all the outputs from the first learning model M1 in response to inputs other than the adversarial example are handled as outputs each matching the label.

According to the fifth embodiment, it is possible to construct a learning model having adversarial example resistance and also maintaining the behavior of an exemplar model not having the adversarial example resistance. This allows a learning model not having the adversarial example resistance to be replaced with a learning model having the adversarial example resistance.

In the first and second examples of the fifth embodiment also, it is possible to perform the checking considering the n-th and lower order differences shown in the second embodiment. For example, in the checking considering the n-th and lower order differences, (s−1)-th and lower order differences are formed in s(t) output sequences (where s(t) n is satisfied) of the first learning model M1 each matching the label. Likewise, in the corresponding output sequences of the second learning model M2, (s(t)−1)-th and lower order differences are formed. The checking may be performed appropriately using a property for checking whether or not the distance, error, or loss function between the corresponding u-th and lower order differences (where 0≤u≤s(t) is satisfied) is not more than ε. This checking is assumed to be behavioral equivalence checking considering n-th and lower order differences intended for an adversarial example resistant model. Note that t represents the order of data items herein

### Sixth Embodiment

In a sixth embodiment, the evaluation method described in the fifth embodiment is combined with the training method shown in FIG. 21 and the like in the fourth embodiment. By doing so, it is possible to train a model having an adversarial example property, while allowing the behavioral equivalence to the exemplar model to be maintained as much as possible.

By performing training considering (n+k)-th and lower order differences, a training device according to the present embodiment implements training which allows smoother behavioral equivalence to be maintained as much as possible. Also, as the equivalence checking, behavioral equivalence checking considering the n-th and lower order differences, which is a less strict condition, is used appropriately. Then, among the student pre-trained models that have succeeded in the checking, a most accurate, i.e., likeliest student pre-trained model is constructed by cross-validation. However, it is assumed that, in training to which an adversarial example is input, a student learning model is trained using the teacher label of training data without using outputs from a pre-trained teacher model.

In training considering the n-th and lower order differences, (s(t)−1)-th and lower order differences are formed in s(t) output sequences (where s(t) n is satisfied) of the first learning model M1 each matching the label. Also, training is assumed to be performed by similarly forming (s−1)-th and lower order differences in the corresponding output sequences of the second learning model M2 and forming the distance, error, or loss function between the corresponding u-th and lower order differences (where 0≤u≤s(t) is satisfied). Note that t represents the order of data items herein.

FIG. 26 is a flow chart showing a training method according to the present embodiment. In FIG. 26, the evaluation method in the fifth embodiment is applied to the training method illustrated in FIGS. 18 to 20 and the like.

The following will describe an example in which the evaluation method according to the first example of the fifth embodiment is adopted. However, the evaluation method according to the second example thereof may also be adopted. In addition, it is assumed that the input parameters required by behavioral equivalence checking for an adversarial example resistant model are given as appropriate.

The signs seen in FIG. 26 are as follows.

n: An input parameter representing a difference to be considered, which is an integer of not less than 0

k: An input parameter representing the offset of the difference to be considered, which is an integer of not less than First, as shown in FIGS. 18 to 20, machine learning training considering the (n+k)-th and lower order differences which allows behavioral equivalence to be maintained is implemented (S221). As a result, the pre-trained student model 151 is constructed. The student pre-trained model 151 internally includes (n+k+1) pre-trained student models considering no difference.

Among the (n+k+1) models 151, n-th and lower order difference models are extracted (S222). In other words, partial models of the (n+1) pre-trained models 152 having outputs from out_s(t+n+k) to out_s(t+k) are acquired.

Behavioral equivalence checking for an adversarial example considering n-th and lower order differences is performed (S223). The behavioral equivalence checking shown in FIG. 24 or 25 is performed herein. In other words, the behavioral equivalence is checked using test data obtained by constructing an adversarial example for each data item.

On the basis of the result of the behavioral equivalence checking, it is determined whether or not the models have sufficient behavioral equivalence therebetween (S224). In other words, it is determined whether or not the behaviors thereof match with a probability of not less than the required probability Θ. When the probability that the behaviors thereof match is not less than Θ, it is determined that the models have sufficient behavioral equivalence therebetween. When the probability that the behaviors thereof match is less than Θ, it is determined that the models do not have sufficient behavioral equivalence therebetween.

When it is determined that the models do not have sufficient behavioral equivalence therebetween (NO in S224), the process moves to S229. When it is determined that the models have sufficient behavioral equivalence therebetween (YES in S224), the pre-trained model is divided (S225). As a result, (n+1) pre-trained models 153 are stored.

Then, cross-validation is performed on the (n+1) pre-trained models (S226). It is determined whether or not the (n+1) pre-trained models include a model that has succeeded in the equivalence checking for the adversarial example resistant model shown in FIG. 24 and the like and has sufficient accuracy (S227). When it is determined that there is no model having sufficient accuracy (NO in S227), the process moves to S229. When it is determined that there is a model having sufficient accuracy (YES in S227), the pre-trained model having the highest accuracy is selected (S228). In other words, the model having the highest probability of satisfying the logical formula ϕ is selected as the likeliest pre-trained model.

By thus doing so, it is possible to output a most accurate model among the models that have succeeded in the behavioral equivalence checking for the adversarial example resistant model. This allows for construction of a learning model having the adversarial example resistance and also maintaining the behavioral equivalence to the exemplar model. When the exemplar model has adversarial example resistance, it is also possible to improve the adversarial example resistance, while allowing the behavioral equivalence to be maintained.

In S229, the parameters n and k are adjusted, and then the process returns to S221. Specifically, for example, the parameter adjustment in S229 is performed as follows. After n=0 is established, k is increased from 1 to 5 in 1 increments. When YES is not given as the result of the determination in S227 before k becomes 5, n is incremented. Specifically, n is increased by 1, while k is similarly increased from 1 to 3 in 1 increments. It may also be possible to repeat the updating of n and k until n=5 is satisfied. It may also be possible that, when sufficient behavioral equivalence is not obtained as a result of the repeating, the process is ended. It is assumed herein that n and k are static variables. Needless to say, n and k are not limited to the values shown above.

### First Modification of Sixth Embodiment

In a first modification of the sixth embodiment, the evaluation method described in the fifth embodiment is combined with the training method illustrated in FIG. 23 and the like in the fourth embodiment. By doing so, it is possible to train a model having adversarial example resistance and also maintaining the behavioral equivalence to the exemplar model as much as possible.

The training device according to the first modification implements training considering (n+k)-th and lower order differences and thus implements training which allows smoother behavioral equivalence to be maintained as much as possible. Also, as the equivalence checking, behavioral equivalence checking considering the n-th and lower order differences, which is a less strict condition, is used appropriately. Then, among the pre-trained student models that have succeeded in the checking, a most accurate, i.e., likeliest student pre-trained model is constructed by cross-validation. At the stage where adversarial example data is formed, an appropriate teacher label is added thereto. Consequently, not only outputs from a teacher pre-trained model having a certain degree of adversarial example resistance, but also outputs from a teacher pre-trained model having no adversarial example resistance can be converted to appropriate labeled teacher data by output adjustment. Note that, in the output adjustment, appropriate parameters p and 1 are set.

FIG. 27 is a flow chart showing the training method according to the first modification of the present sixth embodiment. In FIG. 27, the evaluation method in the fifth embodiment is applied to the training method illustrated in FIGS. 18 to 20 and the like. Also, in FIG. 27, the output adjustment 104 performed on the exemplar model which is shown in FIGS. 15 to 17 is performed.

The signs seen in FIG. 27 are as follows.

n: An input parameter representing a difference to be considered, which is an integer of not less than 0

k: An input parameter representing the offset of the difference to be considered, which is an integer of not less than

l: An input parameter to the output adjustment algorithm, which is an integer of not less than 1

p: An input parameter to the output adjustment algorithm, which is a real number larger than 0.5 and smaller than 1.0

As shown in FIGS. 18 to 20, machine learning training considering the (n+k)-th and lower order differences which allows behavioral equivalence to be maintained is implemented (S241). As a result, the student pre-trained model 151 is constructed. The student pre-trained model 151 internally includes (n+k+1) pre-trained student models considering no difference.

Among the (n+k+1) models 151, n-th and lower order difference models are extracted (S242). In other words, partial models of the (n+1) pre-trained models 152 having outputs from out_s(t+n+k) to out_s(t+k) are acquired.

Behavioral equivalence checking for an adversarial example considering n-th and lower order differences is performed (S243). The behavioral equivalence checking shown in FIG. 24 or 25 is performed herein. In other words, the behavioral equivalence is checked using test data obtained by constructing an adversarial example for each data item.

On the basis of the result of the behavioral equivalence checking, it is determined whether or not the models have sufficient behavioral equivalence therebetween (S244). In other words, it is determined whether or not the behaviors thereof match with a probability of not less than the required probability Θ. When the probability that the behaviors thereof match is not less than Θ, it is determined that the models have sufficient behavioral equivalence therebetween. When the probability that the behaviors thereof match is less than Θ, it is determined that the models do not have sufficient behavioral equivalence therebetween.

When it is determined that the models do not have sufficient behavioral equivalence therebetween (NO in S244), the process moves to S249. When it is determined that the models have sufficient behavioral equivalence therebetween (YES in S244), the pre-trained model is divided (S245). As a result, the (n+1) pre-trained models 153 are stored.

Then, cross-validation is performed on the (n+1) pre-trained models (S246). It is determined whether or not the (n+1) pre-trained models include a model that has succeeded in the equivalence checking for the adversarial example resistant model shown in FIG. 24 and the like and has sufficient accuracy (S247). When it is determined that there is no model having sufficient accuracy (NO in S247), the process moves to S249. When it is determined that there is a model having sufficient accuracy (YES in S247), the pre-trained model having the highest accuracy is selected (S248). In other words, the model having the highest probability of satisfying the logical formula ϕ and highest accuracy is selected as the likeliest pre-trained model.

By thus doing so, it is possible to output a most accurate model among the models that have succeeded in the behavioral equivalence checking for the adversarial example resistant model. This allows for construction of a learning model having the adversarial example resistance and also maintaining the behavioral equivalence to the exemplar model.

In S249, the parameters l, p, n, and k are adjusted, and then the process returns to S241. For example, the parameter adjustment in S249 is performed as follows. While n=0 is established and k is increased from 1 to 5 in 1 increments, 1=1 is established and p is increased from 0.6 in 0.1 increments. As a result, when YES is not given as the result of the determination in S247, l is incremented and p is similarly increased from 0.6 in 0.1 increments. Such updating of the parameters l and p is repeated until 1=5 is satisfied or YES is given in S247.

When YES is not given as the result of the determination in 247, n is incremented and k is similarly increased from 1 to 3 in 1 increments, while l=1 is established and p is increased from 0.6 in 0.1 increments. When YES is not given as the result of the determination in 247, l is incremented and p is similarly increased from 0.6 in 0.1 increments. Such updating of the parameters l and p is repeated until l=5 is satisfied or YES is given as the result of the determination in S247. It may also be possible to repeat the updating of l, p, n, and k until n=5 is satisfied. It may also be possible that, when sufficient behavioral equivalence is not obtained in S244 as a result of the repeating, the process is ended. It is assumed herein that 1, p, n, and k are static variables. Needless to say, l, p, n, and k are not limited to the values shown above.

### Another Embodiment

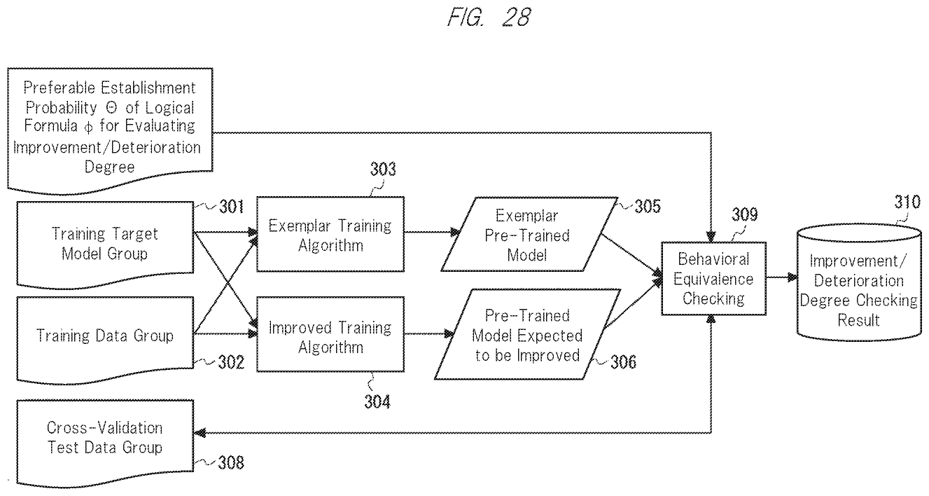

Using FIG. 28, a description will be given of a training device according to another embodiment. It is assumed herein that there is a training algorithm serving as an exemplar and, when the algorithm is improved, the degree to which the improved algorithm has been improved is checked. As the checking, the behavioral equivalence checking described above is used. It is assumed herein that a plurality of sets of a training target model, training data corresponding thereto, and cross-validation data intended for a pre-trained model are prepared.

In FIG. 28, first, a training target model group 301 and a training data group 302 corresponding thereto are acquired. In addition, a cross-validation test data group 308 intended for an exemplar pre-trained model 305 and a pre-trained model 306 are acquired. Using the training target model group 301 and the training data group 302 corresponding thereto, training based on an exemplar training algorithm 303 and training based on an improved training algorithm 304 are individually performed.

By the training based on the exemplar training algorithm, the exemplar pre-trained model 305 is constructed. On the other hand, by the training based on the improved training algorithm 304, the pre-trained model 306 expected to be improved is constructed. The exemplar pre-trained model 305 and the pre-trained model 306 expected to be improved are stored in a memory.

Using the cross-validation test data group 308, behavioral equivalence checking 309 is performed on the exemplar pre-trained model 305 and on the pre-trained model 306 expected to be improved. For the equivalence checking, the method illustrated in FIG. 5, FIG. 6, or the like can be used. An improvement/deterioration degree checking result 310 as the result of executing the behavioral equivalence checking 309 is stored in the memory.

By repeating the process described above, it is possible to check to what degree which training target model is improved/deteriorated. This allows the improved algorithm to be checked.

The probability of the present checking may also be checked separately from the execution of the algorithm in the behavioral equivalence checking performed on each of the learning models by applying thereto the Bayesian hypothetical testing in FIG. 7 or the Bayesian interval estimation method in FIG. 8.

As the logical formula ϕ used in the behavioral equivalence checking, the logical formula ϕ used in the fifth or sixth example of the first embodiment can be used.

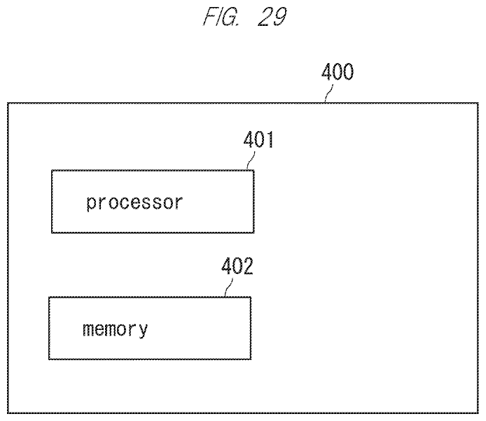

FIG. 29 is a block diagram showing a device 400 for implementing a method according to the present embodiment. The device 400 is a computer including a processor 401 and a memory 402. As described above, the device 400 implements the evaluation method for evaluating the behaviors of the learning models. Alternatively, the device 400 implements a training method for training the learning models.

In the memory 402, a program for performing the process described above is held. In the memory 402, test data for evaluation or the like is also held. The processor 401 is a CPU or the like and executes re-programming (program updating). Note that each of the memory 402 and the processor 401 is not limited to a physically single device.

When the device 400 is an evaluation device for evaluating the learning models, the processor 401 executes the evaluation program stored in the memory 402. This allows the learning models to be appropriately evaluated. Alternatively, when the device 400 is a training device which implements machine learning, the processor executes the training program stored in the memory 402. This allows the learning models to be appropriately trained. The device 400 may also output a comparison result obtained by comparing the behaviors of the learning models with each other or the result of evaluating the learning models. For example, the device 400 may also include a monitor for displaying the comparison result and the evaluation result. This allows a user to check whether or not the learning model successfully maintains the behavior.

In the behavioral equivalence checking method shown in the first embodiment, the second embodiment, or the like, supervised learning, unsupervised learning, semi-supervised learning, reinforcement learning, or a combination thereof can be used to train each of the exemplar model and the target model. It may also be possible to use either different training methods or the same training method to train the exemplar model and the target model. For example, it may also be possible to use unsupervised learning to train the exemplar model and use supervised learning to train the target model.

In the training method which allows the behavior to be maintained shown in the third or fourth embodiment, it is possible to use supervised learning to train the target model and use supervised learning, unsupervised learning, semi-supervised learning, reinforcement learning, or a combination thereof to train the exemplar model.

In the training method handling the adversarial example shown in the fifth or sixth embodiment, it is possible to use supervised learning to train the target model and use supervised learning, unsupervised learning, semi-supervised learning, reinforcement learning, or a combination thereof to train the exemplar model.

In the checking method for the training algorithm shown in the other embodiment, it is possible to use supervised learning, unsupervised learning, semi-supervised learning, reinforcement learning, or a combination thereof to train each of the exemplar model and the target model. It may also be possible to use either different training methods or the same training method to train the exemplar model and the target model. For example, it may also be possible to use unsupervised learning to train the exemplar model and use supervised learning to train the target model.

According to the present embodiment, the following effects can be obtained. It is possible to compare the respective behaviors of two models which cannot be discriminated from each other on the basis only of the accuracies of the learning models or an information criterion. This allows for appropriate selection of the learning models. In addition, using the comparison method described above, comparison considering term arrangement in a sequence can be made. This allows for appropriate selection of a learning model to which term arrangement in a sequence is significant. It is possible to provide an improved learning model which maintains the behavior of the pre-improvement model as much as possible. It is possible to simplify a learning model or replace the learning model with a simpler learning model, while allowing the behavior of the pre-improvement model to be maintained as much as possible. Particularly in Neural Network training, it is possible to implement training having Adversarial Example resistance which allows the behavior of the pre-improvement model to be maintained as much as possible.

Some or all of the embodiments described above may also be described otherwise as in the following notes, but are not limited to the following.

Notes:

(Note 1)

A training device performs the steps of:
(1) obtaining, using training data, a first output result based on a first learning model as a teacher model;
(2) obtaining, using the training data, a second output result based on a second learning model as a student model;
(3) performing, using an evaluation parameter based on the first and second output results, training of the second learning model; and
(4) comparing respective behaviors of the first output result and the pre-trained second output result with each other.

(Note 2) In the training device according to Note 1,

the step (4) includes the steps of:
(4-1) obtaining, using checking data, a first program arithmetic result based on the first learning model;
(4-2) obtaining, using the checking data, a second program arithmetic result based on the second learning model;
(4-3) determining whether or not the first and second program arithmetic results satisfy a logical formula; and
(4-4) evaluating, using a Bayesian statistical model checking method, behavioral equivalence between the first and second learning models on the basis of a result of the determination in the step (4-3).

(Note 3) In the training device according to Note 1,

the training data is labeled data with a label,
the step ϕ includes adjusting, using an adjustment parameter, the first output data on the basis of the label,
the step (3) includes performing, using an evaluation parameter based on the adjusted first output data and the second output result, training of the second learning model, and
the step (4) includes changing the adjustment parameter when the behaviors do not satisfy a predetermined criterion.

(Note 4) In the training device according to Note 1,

the steps (1) and (2) include:
sequentially inputting sequence data as the training data; and
calculating (n+k)-th (each of n and k is an integer of not less than 0) and lower order differences in output sequence data corresponding to the sequence data,
the step (3) includes performing, using an evaluation parameter based on the first and second output results including the (n+k)-th and lower order differences, training of the second learning model to construct (n+k+1) pre-trained models, and
the step (4) includes the steps of:
acquiring, from among the (n+k+1) pre-trained models, partial models including n-th and lower order differences;
(4-1) obtaining, using checking data as sequence data, a first execution result based on the first learning model;
(4-2) obtaining, using the checking data, a second execution result based on the partial models;
(4-3) determining whether or not the first and second execution results including the n-th and lower order differences satisfy a logical formula;
(4-4) evaluating, using a Bayesian statistical model checking method, behavioral equivalence between the first learning model and the second learning model on the basis of a result of the determination in the step (4-3); and
(4-5) selecting, when the behavioral equivalence satisfies a predetermined criterion in the step (4-4), a most accurate learning model from among (n+1) learning models.

(Note 5) In the training device according to Note 4,

when the behavioral equivalence does not satisfy the predetermined criterion in the step (4-4), at least one of the n and k is changed.

(Note 6) In the training device according to Note 1,

the step (4) includes using checking data including labeled data forming an adversarial example.

(Note 7) An evaluation method comprises the steps of:
implementing, using training data, training based on an exemplar training algorithm to construct an exemplar learning model;
implementing, using the training data, training based on an improved training algorithm to construct an improved learning model;
obtaining, using checking data, a first execution result based on the exemplar learning model;

obtaining, using the checking data, a second execution result based on the improved learning model;
determining whether or not the first and second execution results satisfy a logical formula; and
evaluating, using a Bayesian statistical model checking method, the improved training algorithm on the basis of a result of the determination of whether or not the logical formula is satisfied.

While the invention achieved by the present inventors has been specifically described heretofore on the basis of the embodiments, the present invention is not limited to the embodiments already described. It will be appreciated that various changes and modifications can be made in the invention within the scope not departing from the gist thereof.

What is claimed is:

1. A method of evaluating learning models by using a memory and a processor, the method comprising the steps of:
(A) generating a first execution result of a first learning model as an exemplar model using checking data by the processor;
(B) generating a second execution result of a second learning model using the checking data by the processor;
(C) determining whether or not the first and second execution results satisfy a predetermined logical formula by the processor; and
(D) comparing by the processor, using a Bayesian statistical model checking method, respective behaviors of the first and second learning models with each other on the basis of a result of the determination in the step (C).

2. The method of evaluating the learning models according to claim 1,
wherein the step (D) includes:
calculating a Bayes factor for a hypothesis associated with an establishment probability of the logical formula;
performing Bayesian hypothetical testing to determine whether or not the establishment probability is not less than a probability threshold; and
evaluating, based on a result of the Bayesian hypothetical testing, behavioral equivalence between the first learning model and the second learning model.

3. The method of evaluating the learning models according to claim 1,
wherein the step (D) includes:
calculating a confidence interval which satisfies an establishment probability of the logical formula;
calculating a posterior probability on the basis of the confidence interval; and
evaluating, on the basis of the posterior probability, behavioral equivalence between the first learning model and the second learning model.

4. The method of evaluating the learning models according to claim 1,
wherein the steps (A) and (B) include:
sequentially inputting sequence data as the checking data; and
determining n-th (n is an integer of not less than 1) and lower order differences in output sequence data corresponding to the sequence data, and
wherein the step (C) includes determining whether or not the first and second execution results including one or more of the n-th and lower order differences satisfy the logical formula.

5. A device for evaluating learning models which performs the steps of:
(A) obtaining, using checking data, a first execution result based on a first learning model as an exemplar model;
(B) obtaining, using the checking data, a second execution result based on a second learning model;
(C) determining whether or not the first and second execution results satisfy a logical formula; and
(D) comparing, using a Bayesian statistical model checking method, respective behaviors of the first and second learning models with each other on the basis of a result of the determination in the step (C).

6. The device for evaluating the learning models according to claim 5,
wherein the step (D) includes:
calculating a Bayes factor for a hypothesis associated with an establishment probability of the logical formula;
performing Bayesian hypothetical testing to determine whether or not the establishment probability is not less than a probability threshold; and
evaluating, based on a result of the Bayesian hypothetical testing, behavioral equivalence between the first learning model and the second learning model.

7. The device for evaluating the learning models according to claim 5,
wherein the step (D) includes:
calculating a confidence interval which satisfies an establishment probability of the logical formula;
calculating a posterior probability on the basis of the confidence interval; and
evaluating, on the basis of the posterior probability, behavioral equivalence between the first learning model and the second learning model.

8. The device for evaluating the learning models according to claim 5,
wherein the steps (A) and (B) include:
sequentially inputting sequence data as the checking data; and
determining n-th (n is an integer of not less than 1) and lower order differences in output sequence data corresponding to the sequence data, and
wherein the step (C) includes determining whether or not the first and second execution results including one or more of the n-th and lower order differences satisfy the logical formula.

9. A computer readable storage medium for causing a computer to implement the method of evaluating the learning models according to claim 1.

10. A training method which is implemented by using a memory and a processor, the training method comprising the steps of:
(1) obtaining, using training data, a first output result based on a first learning model as a teacher model;
(2) obtaining, using the training data, a second output result based on a second learning model as a student model;
(3) performing, using an evaluation parameter based on the first and second output results, training of the second learning model; and
(4) comparing respective behaviors of the first learning model and the pre-trained second learning model with each other.

11. The training method according to claim 10,
wherein the step (4) includes the steps of:
(4-1) obtaining, using checking data, a first execution result based on the first learning model;
(4-2) obtaining, using the checking data, a second execution result based on the second learning model;
(4-3) determining whether or not the first and second execution results satisfy a logical formula; and
(4-4) evaluating, using a Bayesian statistical model checking method, behavioral equivalence between the first learning model and the second learning model on the basis of a result of the determination in the step (4-3).

12. The training method according to claim 10,
wherein the training data is labeled data with a label,
wherein the step (1) includes adjusting, using an adjustment parameter, the first output data on the basis of the label,
wherein the step (3) includes performing, using an evaluation parameter based on the adjusted first output data and the second output result, training of the second learning model, and
wherein the step (4) includes changing the adjustment parameter when the behaviors do not satisfy a predetermined criterion.

13. The training method according to claim 10,
wherein the steps (1) and (2) include:
sequentially inputting sequence data as the training data; and
calculating (n+k)-th (each of n and k is an integer of not less than 0) and lower order differences in output sequence data corresponding to the sequence data,
wherein the step (3) includes performing, using an evaluation parameter based on the first and second output results including the (n+k)-th and lower order differences, training of the second learning model to construct (n+k+1) pre-trained models, and
wherein the step (4) includes the steps of:
acquiring, from among the (n+k+1) pre-trained models, partial models including n-th and lower order differences;
(4-1) obtaining, using checking data as sequence data, a first execution result based on the first learning model;
(4-2) obtaining, using the checking data, a second execution result based on the partial models;
(4-3) determining whether or not the first and second execution results including the n-th and lower order differences satisfy a logical formula;
(4-4) evaluating, using a Bayesian statistical model checking method, behavioral equivalence between the first learning model and the second learning model on the basis of a result of the determination in the step (4-3); and
(4-5) selecting, when the behavioral equivalence satisfies a predetermined criterion in the step (4-4), a most accurate learning model from among (n+1) learning models.

14. The training method according to claim 13,
wherein, when the behavioral equivalence does not satisfy the predetermined criterion in the step (4-4), at least one of the n and k is changed.

15. The training method according to claim 10,
wherein the step (4) includes using checking data including labeled data forming an adversarial example.

16. A computer readable storage medium for causing a computer to implement the training method according to claim 10.
